(19) United States
(12) Patent Application Publication
(10) Pub. No.: US 2024/0389138 A1
(43) Pub. Date: Nov. 21, 2024

(54) REPRESENTATIVE AND REPRESENTED STAs FOR P2P OPERATION

(71) Applicant: Samsung Electronics Co., Ltd., Suwon-si (KR)

(72) Inventors: Yue Qi, Plano, TX (US); Rubayet Shafin, Allen, TX (US); Boon Loong Ng, Plano, TX (US); Vishnu Vardhan Ratnam, Plano, TX (US); Elliot Jen, Taipei City (TW); Bilal Sadiq, Plano, TX (US); Peshal Nayak, Plano, TX (US)

(21) Appl. No.: 18/651,509

(22) Filed: Apr. 30, 2024

Related U.S. Application Data
(60) Provisional application No. 63/467,736, filed on May 19, 2023.
(60) Provisional application No. 63/521,026, filed on Jun. 14, 2023.
(60) Provisional application No. 63/524,493, filed on Jun. 30, 2023.
(60) Provisional application No. 63/528,002, filed on Jul. 20, 2023.
(60) Provisional application No. 63/532,136, filed on Aug. 11, 2023.

(51) Int. Cl. H04W 74/08; H04W 52/02; H04W 92/18

(52) U.S. Cl. CPC H04W 74/08; H04W 52/0225; H04W 92/18

(57) ABSTRACT

A first station (STA) in a wireless network, the first STA can communicate with a second STA on a first channel, determine a need to switch to a second channel, determine that the first STA is a representative STA and the second STA is a represented STA, transmit a frame to an access point (AP) to notify the AP device of a power save (PS) mode for the first STA and the second STA, perform a channel switch to the second channel, and communicate with the second STA on the second channel as a peer to peer (P2P) group.

### CROSS-REFERENCE TO RELATED APPLICATIONS

This application claims the benefit of priority from U.S. Provisional Application No. 63/467,736, entitled “Representative STA Indicating P2P Group Operation,” filed May 19, 2023, U.S. Provisional Application No. 63/521,026, entitled “Representative STA Indicating P2P Group Operation” filed Jun. 14, 2023, U.S. Provisional Application No. 63/524,493, entitled “Method and Apparatus for Representative and Represented Behaviors in STAs” filed Jun. 30, 2023, U.S. Provisional Application No. 63/528,002, entitled “Method and Apparatus for Representative and Represented Behaviors in STAs” filed Jul. 20, 2023, and U.S. Provisional Application No. 63/532,136, entitled “Method and Apparatus for Representative and Represented Behaviors in STAs” filed Aug. 11, 2023, which are all incorporated herein by reference in their entirety.

### TECHNICAL FIELD

This disclosure relates generally to a wireless communication system, and more particularly to, for example, but not limited to, representative and represented STAs for P2P operation.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network. The first STA includes a memory and a processor coupled to the memory. The processor is configured to communicate with a second STA on a first channel. The processor is configured to determine a need to switch to a second channel. The processor is configured to determine that the first STA is a representative STA and the second STA is a represented STA. The processor is configured to transmit a frame to an access point (AP) to notify the AP of a power save (PS) mode for the first STA and the second STA. The processor is configured to perform a channel switch to the second channel. The processor is configured to communicate with the second STA on the second channel as a peer to peer (P2P) group.

In some embodiment, the first STA initiates the switch to the second channel with the second STA, wherein the processor is configured to transmit a channel switch request frame to the second STA.

In some embodiment, the processor is configured to receive a channel switch request frame from the second STA. The processor is configured to processes the channel switch request frame and agree to switch channels to the second channel and become the representative STA on behalf of itself and the second STA. The processor is configured to contend for a medium. The processor is configured to transmit a channel switch response frame to the second STA.

In some embodiment, the first STA is associated with the AP and the second STA is not associated with the AP in a basic service set (BSS) and the second STA uses a different P2P protocol.

In some embodiment, the first STA and the second STA are associated with the AP in a basis service set (BSS).

In some embodiment, the processor is configured to broadcast a first frame that includes a first preference rank of the first STA, receive a second frame from the second STA that includes a second preference rank of the second STA, and determine the representative STA and the represented STA based on the first preference rank and the second preference rank.

In some embodiment, the processor is configured to: transmit a service request frame to the second STA to notify that the first STA intends to become the representative STA, and receive a service negotiation response frame from the second STA to notify that the second STA intends to become the represented STA.

In some embodiment, the processor is configured to transmit a first frame to the AP that includes the first preference rank, and received a second frame from the AP that sets the first STA as the representative STA and the second STA as the represented STA.

In some embodiment, the processor is configured to transmit a handover request frame to at least one of the second STA to set the second STA as the representative STA, and transmit a report frame to the AP to notify the AP that the first STA is leaving the P2P group.

One aspect of the present disclosure provides an access point (AP) device in a wireless network. The AP device comprising a memory and a processor coupled to the memory. The processor is configured to receive a plurality of frames from a plurality of stations (STAs) associated with the AP, including a first frame from a first STA and a second frame from a second STA. The processor is configured to determine that the first STA is a representative STA and the second STA is a represented STA based on the plurality of frames. The processor is configured to transmit a frame to the first STA and a frame the second STA that specifies the role of the first STA as the representative STA and the second STA as the represented STA.

In some embodiment, the processor is configured to: receive a frame from the first STA that indicates to put the first STA and the second STA into a power save (PS) mode; and set the first STA and the second STA into the PS mode.

In some embodiment, the processor is configured to transmit a representative request frame to the plurality of STAs associated with the AP to trigger the plurality of frames from the plurality of STAs.

In some embodiment, the processor is configured to determine ranks for the plurality of STAs, and set roles for the STAs, including the representative STA and the represented STA, based on the ranks.

In some embodiment, the processor is configured to: receive a handover request frame from the first STA, set the second STA as the representative STA, and transmit a frame to the second STA that updates the role of the second STA to the representative STA.

One aspect of the present disclosure provides a computer-implemented method for facilitating communication at a first station (STA) in a wireless network. The method includes communicating with a second STA on a first channel, determining a need to switch to a second channel, determining that the first STA is a representative STA and the second STA is a represented STA, transmitting a frame to an access point (AP) to notify the AP of a power save (PS) mode for the first STA and the second STA, performing a channel switch to the second channel, and communicating with the second STA on the second channel as a peer to peer (P2P) group.

In some embodiment, the first STA initiates the switch to the second channel with the second STA, wherein the method further comprises transmitting a channel switch request frame to the second STA.

In some embodiment, the computer-implemented method further includes receiving a channel switch request frame from the second STA, processing the channel switch request frame and agree to switch channels to the second channel and become the representative STA on behalf of itself and the second STA, contending for a medium, and transmitting a channel switch response frame to the second STA.

In some embodiment, the first STA is associated with the AP and the second STA is not associated with the AP in a basic service set (BSS) and the second STA uses a different P2P protocol.

In some embodiment, the first STA and the second STA are associated with the AP in a basis service set (BSS).

In some embodiment, the computer-implemented method further includes broadcasting a first frame that includes a first preference rank of the first STA, receiving a second frame from the second STA that includes a second preference rank of the second STA, an determining the representative STA and the represented STA based on the first preference rank and the second preference rank.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a TDLS discovery procedure.

FIG. 5 illustrates a TDLS direct-link teardown.

FIG. 6 illustrates a TDLS channel switch frame exchanges.

FIG. 7 illustrates a TDLS direct-link channel switch.

FIG. 8 illustrates a TDLS peer power saving mode.

FIG. 9 illustrates a dense environment where the AP 902 has a heavy load from many P2P groups.

FIG. 10 illustrates a dense environment with representative STAs to reduce an overhead of an AP in accordance with an embodiment.

FIG. 11 illustrate a single BSS with several TDLS devices in accordance with an embodiment.

FIG. 12 illustrates a representative STA in TDLS channel switch in accordance with an embodiment.

FIG. 13 illustrates an example flow chart of a process of a representative TDLS STA in PS mode in accordance with an embodiment.

FIG. 14 illustrates representative STA (e.g., STA2) in TDLS channel switch in accordance with an embodiment.

FIG. 15 illustrates a flow chart of an example process for representative TDLS STA in PS mode.

FIG. 16 illustrates co-existence of multiple P2P in a single BSS in accordance with an embodiment.

FIG. 17 illustrates an example of frame exchanges of a representative STA of P2P indication frame or cross-device unavailability indication frame in accordance with an embodiment.

FIG. 18 illustrates an example flow chart of a process of a representative STA in accordance with an embodiment.

FIG. 19 illustrates periodic frame exchanges in BSS networks in accordance with an embodiment.

FIG. 20 illustrates aperiodic frame exchanges in BSS networks in accordance with an embodiment.

FIG. 21 illustrates multiple TDLS representative STAs in accordance with an embodiment.

FIG. 22 illustrates frame exchanges of multiple representative STAs in accordance with an embodiment.

FIG. 23 illustrates a topology of an STA coordination with a 1:N group in accordance with an embodiment.

FIG. 24 illustrates a topology of the STA coordination of a 1: N: M group in accordance with an embodiment.

FIG. 25 illustrates an example topology for selecting a representative STA in accordance with an embodiment.

FIG. 26 illustrates discovery beacons in accordance with an embodiment.

FIG. 27 illustrates a discovery request and response frame exchange in accordance with an embodiment.

FIG. 28 illustrates a service negotiation frames exchange in accordance with an embodiment.

FIG. 29 illustrates a three-way service negotiation frame exchange in accordance with an embodiment.

FIG. 30 illustrates a frame exchange for phase 3 and phase 4 in accordance with an embodiment.

FIG. 31 illustrates a flow chart of an example process at a representative STA in accordance with an embodiment.

FIG. 32 illustrates a flow chart of an example process at a represented STA in accordance with an embodiment.

FIG. 33 illustrates a flow chart of an example process at an AP in accordance with an embodiment.

FIG. 34 illustrates an example frame exchange in four phases in accordance with an embodiment.

FIG. 35 illustrates an example of a frame exchange in three phases after discovery in accordance with an embodiment.

FIG. 36 illustrates a flow chart of an example process at an STA side in accordance with an embodiment.

FIG. 37 illustrates a flow chart of an example process at an AP side in accordance with an embodiment.

FIG. 38 illustrates transmits a representative request frame exchange in accordance with an embodiment.

FIG. 39 illustrates a flowchart of an example process of representative negotiation procedure determined by an AP in accordance with an embodiment.

FIG. 40 illustrates a flowchart of an example process of representative negotiation procedure at a peer STA in accordance with an embodiment.

FIG. 41 illustrates an example of an STA joining and leaving a group in accordance with an embodiment.

FIG. 42 illustrates an example of a representative STA leaving a P2P group in accordance with an embodiment.

FIG. 43 illustrates an example of a representative STA planning to leave a group and handover the roles to other candidates in accordance with an embodiment.

FIG. 44 illustrates a flow chart of an example process of a handover in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

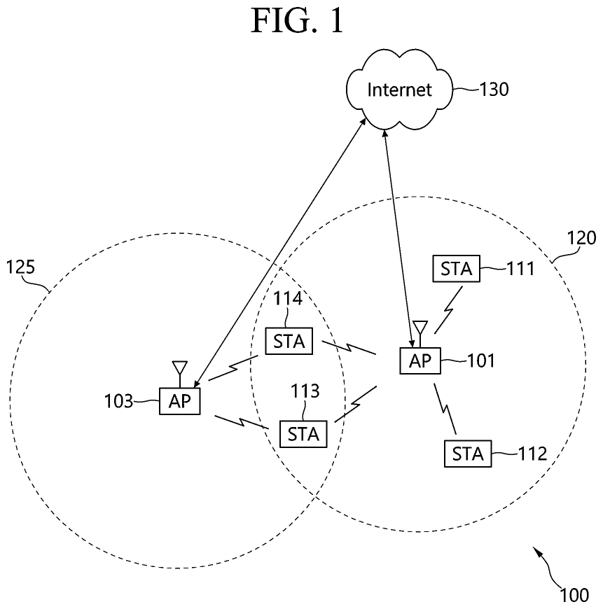

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

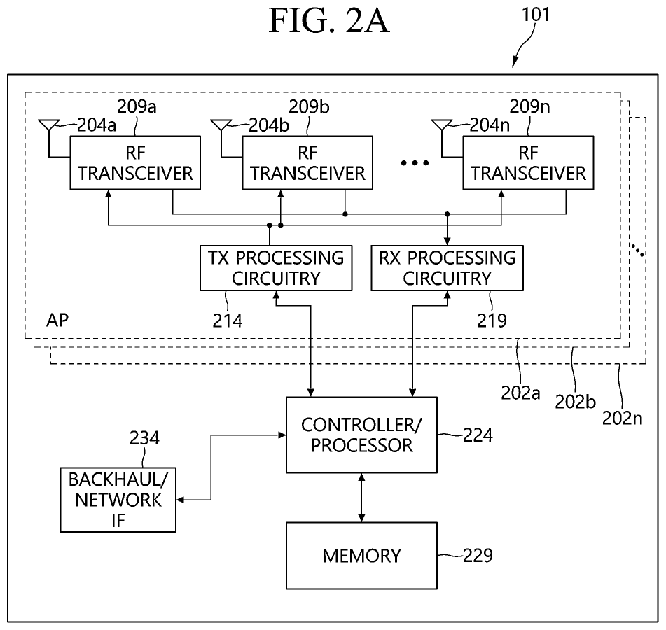

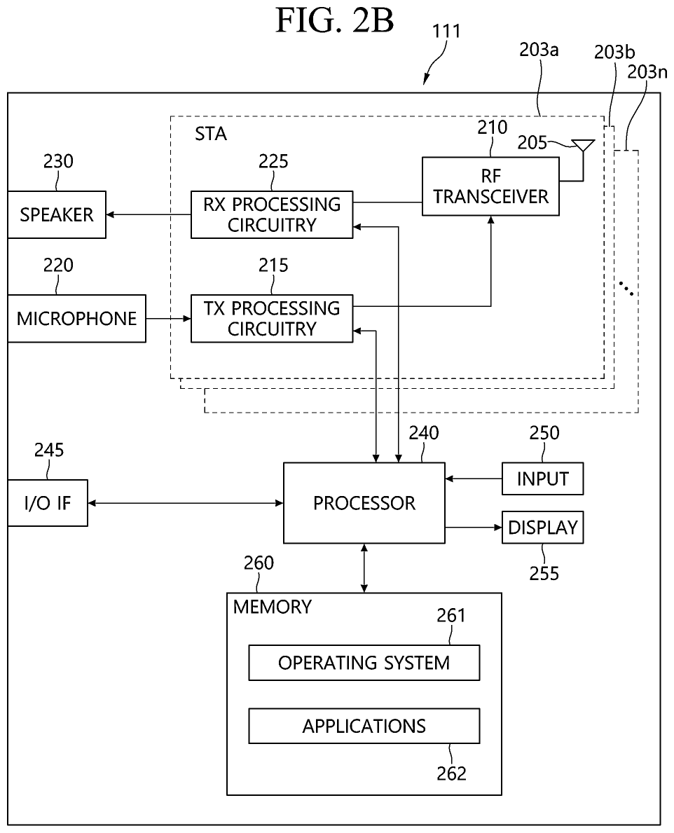

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

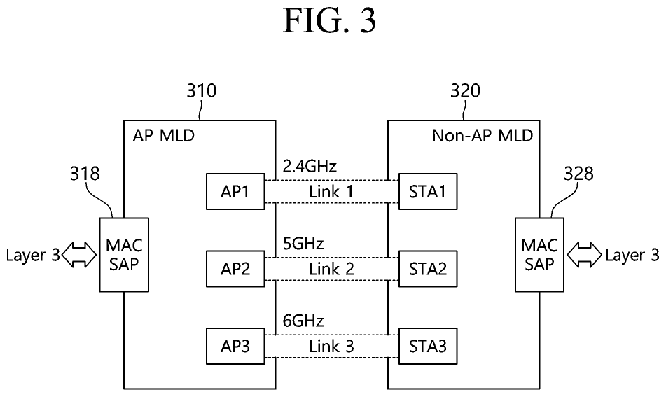

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

With the proliferation of many different types of devices that use wireless communication, including IoT devices, wearables, and AR/VR/XR applications, wireless networks now need to support a larger number of devices. Different devices may use different types of traffic, including Peer-to-Peer (P2P), uplink (UL), and downlink (DL) traffic, among various other types of traffic. Furthermore, each type of traffic may specify a certain a quality of service (QOS) requirement, such as low latency, power saving, among others.

P2P operation has been favored for wireless communication for many devices as it may provide an overall user-friendly experience, including easy setup, fast connection, ultra-speed transmission, and good QoS support, among other benefits. However, applications that use WLAN P2P communications are increasing in a wider range of deployment scenarios and thus may be competing with infrastructure WLAN usage for the same medium resources. Accordingly, better and harmonious coordination between neighboring APs and P2P networks may be beneficial.

Tunneled Direct Link Setup (TDLS) is a main protocol in the IEEE 802.11 standards for P2P. Devices such as TVs, smartphones, cameras, printers, projectors, among others with TDLS designation can set up secure links with each other to directly transfer data. TDLS can include several key procedures including discovery, setup, teardown, power save (PS), and channel switch.

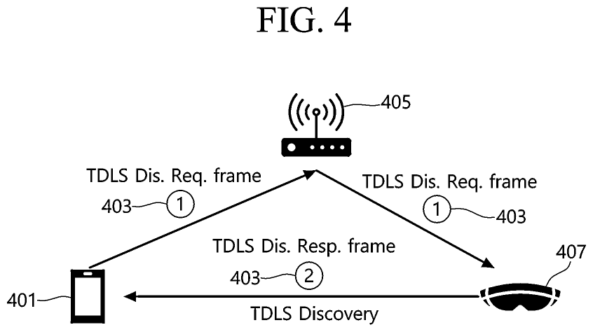

FIG. 4 illustrates a TDLS discovery procedure. TDLS discovery may be used to discover TDLS STAs in the same basis service set (BSS). As illustrated, a TDLS initiator STA 401 sends a TDLS discovery request frame 403 to a target STA 407, through the AP 405. The TDLS STA 407 sends a TDLS discovery response frame 409 to the requesting STA 401 via a direct path. The response frame 409 can include information regarding the STA's capabilities, including, for example, whether the STA supports TDLS or not, the STA's supported rates and/or channels, among other information. TDLS discovery can also allow devices to discover one another other without an AP, by directly sending the TDLS discovery request frame and receiving the TDLS discovery response frame between the STAs. A TDLS STA that receives an unsolicited TDLS discovery request frame may respond with an individually addressed TDLS discovery response frame. A discovery step can be utilized to determine whether a direct link would be more beneficial than using a link via the AP. In particular, by comparing a received signal strength from the target STA 407 to that from the AP 405, the initiating STA device 401 can assess if a direct link will be more efficient than sending the packets via the AP.

TDLS can allow devices to establish a direct-link between one another. To establish a direct TDLS link, the following procedure may be performed. The initiator STA may send a TDLS setup request frame. The TDLS responder STA may respond with a TDLS setup response frame via an AP. The response frame may include a status code indicating either success or request declined (e.g., BSSID does not match). The initiator STA may send a TDLS setup confirm frame confirming whether the connection is direct or if the connection is via the AP. If there is a direct connection, then the initiator STA may directly communicate with the target STA. MAC service data unit (MSDU) transmission via the AP from the initiator STA should be ceased after sending the TDLS setup request frame. MSDU can continue if a setup confirm frame is transmitted or if a response frame is received with an unsuccessful status code.

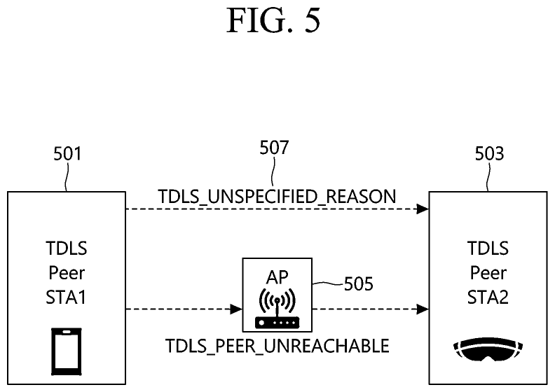

FIG. 5 illustrates a TDLS direct-link teardown. The TDLS direct-link teardown may perform the following procedure. Either the initiator STA 501 or the target STA 503 may send a TDLS teardown frame. The TDLS teardown frame may be sent via the direct path 507 with a reason code (e.g., TDLS_UNSPECIFIED_REASON) or via the AP 505 with a reason code (e.g., TDLS_PEER_UNREACHABLE) when the TDLS peer STA 503 is unreachable via the TDLS direct link.

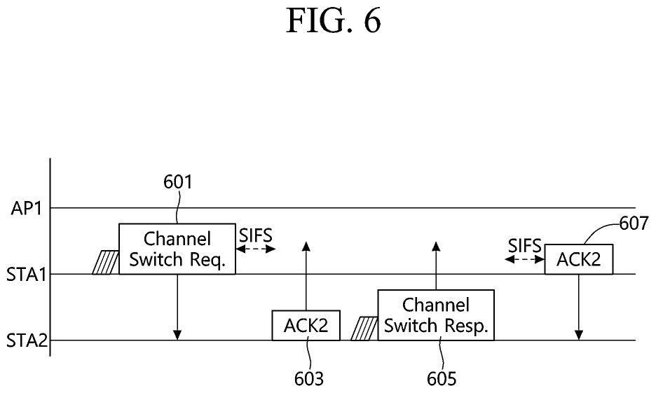

FIG. 6 illustrates a TDLS channel switch. The TDLS channel switch procedure may be performed as follows. The TDLS devices, STA1 and STA2, may negotiate to move to another channel (e.g., an off-channel) to avoid congestion. A TDLS channel switch request frame 601 and a channel switch response frame 605 may operate via the direct link. In particular, STA1 transmits the TDLS channel switch request frame 601 to STA2 and STA2 transmits an acknowledgment frame, ACK1 603, to STA1. STA2 transmits a TDLS channel switch response frame 605 to STA 1, and STA1 transmits an acknowledgement frame, ACK2 607. Both peer STAs, STA1 and STA2, may be listening to the target channel after the ACK2 607. The TDLS STA peers should be in a power saving mode (‘sleep mode’) with the AP, AP1, before switching to the new channels. When operating via the off channel, the TDLS devices may regularly return to the base channel to receive beacons, look at the traffic indication map (TIM) for any buffered packets, and/or communicate with other devices in the network. The TDLS peer STA may be in the PS mode with the AP and may not be involved in an active service period with the AP before sending a TDLS channel switch request frame or a TDLS channel switch response frame with status code set to success. The TDLS peer STA that receives a TDLS channel switch request frame may enter the PS mode with the AP prior to sending the TDLS channel switch response frame.

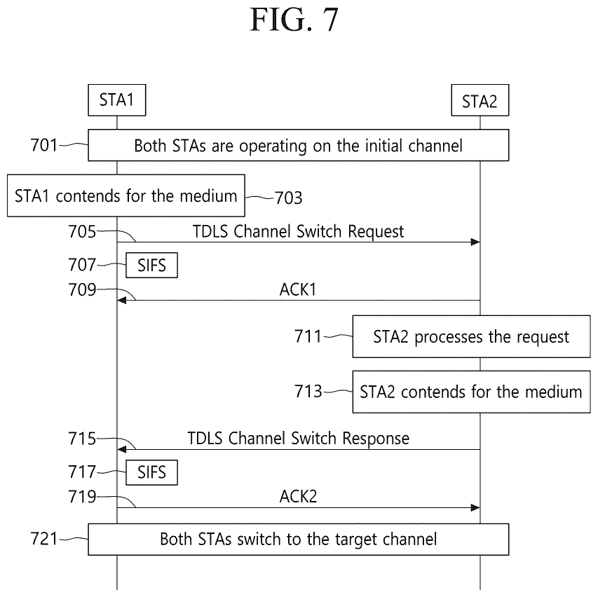

FIG. 7 illustrates a TDLS direct-link channel switch. To indicate to the AP that a STA is changing its power management mode from active mode to power save (PS) mode, a STA may transmit a PPDU with the PM bit in the frame control field set to 1. As illustrated in FIG. 7, in 701, both STAs are operating on an initial channel. In 703, STA1 contents for the medium. In 705, STA1 transmits a TDLS channel switch request frame to STA 2. In 709, STA2 transmits an acknowledgement frame, ACK1, to STA1 a short interframe space (SIFS) 707 after the TDLS channel switch request frame is received. In 711, STA2 processes the request. In 713, STA2 contends for the medium. In 715, STA2 transmits a TDLS channel switch response frame to STA1. In 719, STA1 transmits an acknowledgement frame, ACK2, to STA2 an SIFS 717 after the TDLS channel switch response frame is received. In 721, both STAs switch to the target channel.

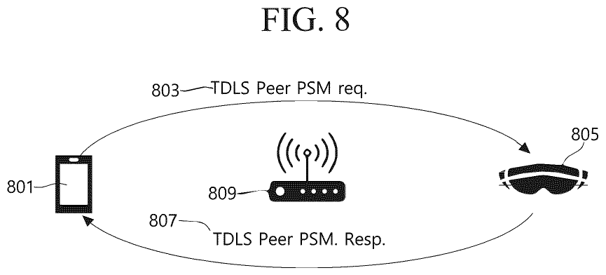

FIG. 8 illustrates a TDLS channel switch. The TDLS can include a power saving mode (PS mode), which may include the following procedure. Both STAs, STA1 801 and STA2 805, may need to support TDLS Peer PS mode. The TDLS Peer PS mode request frame 803 may include a proposed periodic wakeup schedule. The TDLS Peer PS mode response frame 807 can indicate status code as SUCCESS to accept the proposed wakeup schedule. If the responder TDLS STA rejects the schedule, it can propose an alternative schedule, and the PS mode initiator can generate a new request frame, as illustrated in FIG. 8. A TDLS peer PS mode request frame 803 can be transmitted via the AP 809 path or the direct path. A TDLS peer PS mode response frame 807 can be transmitted via the direct path.

Transmission opportunity (TXOP) sharing (e.g., MU RTS TXS mode 2) may be that an AP allocates time within an obtained TXOP to an associated non-AP EHT STA for transmitting one or more non-trigger based physical layer protocol data unit (non-TB PPDUs) sequentially. The STA can then transmit one or more PPDUs to either the AP or another STA. The AP may use a multi-user request to send (MU-RTS) triggered TXOP sharing (TXS) trigger frame for TXOP allocation. Two Modes may be supported in Extremely High Throughput (EHT) WiFi 11be, including Mode-1 and Mode 2. In Mode-1, the STA can use the TXOP to only transmit to the AP. In Mode-2, the STA can use the TXOP to transmit to both AP or the STA. Mode-2 may be a coordinated network linking infrastructure network and P2P network.

When an STA is transitioning to the PS mode to save power, or when the STA prefers some activities such as P2P that may not always require the assistance of AP, the STA can in general notify the AP that the STA is going to the PS mode. Current implementations of P2P may not be efficient to meet the requirement of Ultra High Reliability (UHR) wireless communication, especially in a large group, for the following reasons.

Heavy overload, in particular, when TDLS devices negotiate to move to another channel, for example, from a congested 2.4 GHz channel to a 5 GHz channel, the TDLS devices inform the AP that they are in the PS mode, so that the AP will buffer packets. However, when multiple TDLS devices in a large group are negotiating, each of them may have to inform the AP that it is going to go to PS mode. Accordingly, the overhead of multiple STAs informing the AP may cause a high-burden for AP.

Poor management, in particular when multiple STAs plan to form or join a large P2P group or leave the AP for a period of time, each STA that is associated with the AP may also need to inform AP that it is going to the PS mode. However, this information may be vague to the AP, since the peer STAs are having P2P activities instead of the PS mode. Accordingly, the AP may not be able to assist the STAs in resource management.

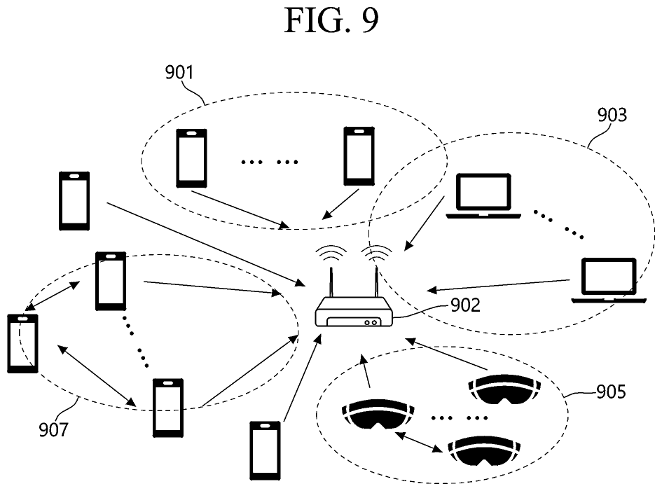

A group of peer STAs may report the same behaviors to the AP. For example, FIG. 9 illustrates a dense environment where the AP 902 has a heavy load from many P2P groups. As illustrated, peers in many P2P groups, including P2P group 901, P2P group 903, P2P group 905, and P2P group 907, are indicating power save mode to the AP 902. However, the AP 902 may have limited resources to hold large P2P groups. Heavy traffic may cause high overhead for the APs and poor manageability of the network, especially in large P2P groups and dense deployments. Therefore, minimizing overhead at the AP may be important for efficient resource utilization and network performance. For example, reducing the unnecessary frame exchanges can help prevent APs from being overloaded, increase AP's availability, and reduce the overall delay.

To reduce the overhead of an AP, one STA, referred to herein as a representative STA, can represent the group as a group leader or representative to communicate with the AP on behalf of other peer STAs.

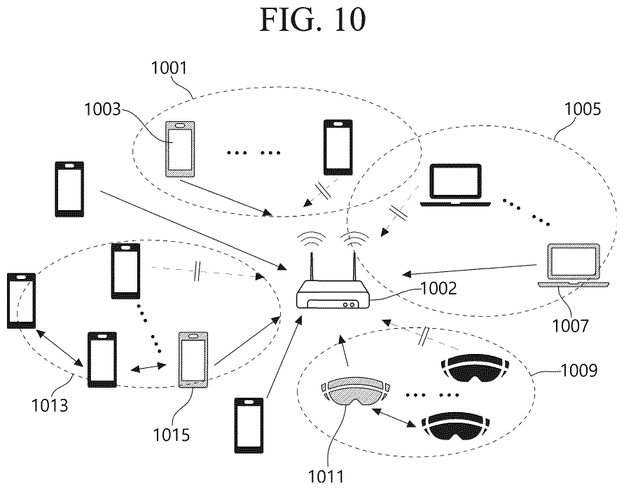

FIG. 10 illustrates a dense environment with representative STAs to reduce an overhead of an AP in accordance with an embodiment. In particular, FIG. 10 illustrates several P2P groups, with each group including several STAs where one STA is a representative STA for the particular P2P group, and an AP, AP1002. As illustrated, P2P group 1001 includes representative STA 1003, P2P group 1005 includes representative STA 1007, P2P group 1009 includes representative STA 1011, and P2P group 1013 includes representative STA 1015.

Use of representative STAs can provide various benefits, including reducing the overhead of AP and improving the management of P2P when there exist multiple types of P2P protocols. Further benefits can include reducing P2P operations signaling overhead, improving P2P operations reliability, mitigating mutual inference between P2P network and infrastructure network, improving resource management and utilization, supporting roaming mobility for P2P, improving interoperability across different P2P mechanisms, among various other benefits.

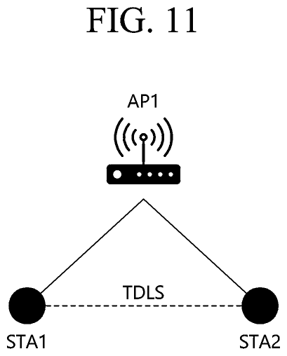

Some embodiments can enhance TDLS in a single BSS for power save. FIG. 11 illustrate a single BSS with several TDLS devices in accordance with an embodiment. AP1 may be served as a single access point. The non-AP STAs, STA1 and STA2, may be associated with AP1. STA1 and STA2 are TDLS devices and have already discovered each other and setup with the AP. The STAs may want to form a group instead of communicating on their current channel that may be congested. To perform the channel switching, the TDLS STAs, STA1 and STA2, may be in the PS mode with AP, AP1. There can be a representative, e.g., STA1, that may help to indicate the PS mode on behalf of other TDLS STAs, e.g., STA2. TDLS channel switching is described in FIG. 6 and FIG. 7.

A TDLS peer STA shall be in the PS mode with the AP and shall not be involved in an active service period (SP) with the AP before sending a TDLS channel switch request frame or a TDLS channel switch response frame with status code set to SUCCESS. The TDLS peer STA that receives a TDLS channel switch request frame may enter the PS mode with the AP prior to sending the TDLS channel switch Response frame. However, each STA that is interested in channel switching may need to be in the PS mode with the AP, which may cause a heavy overhead at the AP, especially when there are a large number of peer devices.

In some embodiments, a channel switching initiator and/or one of the STAs can be a representative STA, which can set the STAs as a group into the PS mode, which can reduce overhead at the AP.

In some embodiments, an STA (e.g., STA1) may be selected as the representative to indicate PS mode to the AP on behalf of itself and other STAs (e.g., STA2). Accordingly, the STA can be in the PS mode with the AP any time before sending a TDLS channel switch request frame.

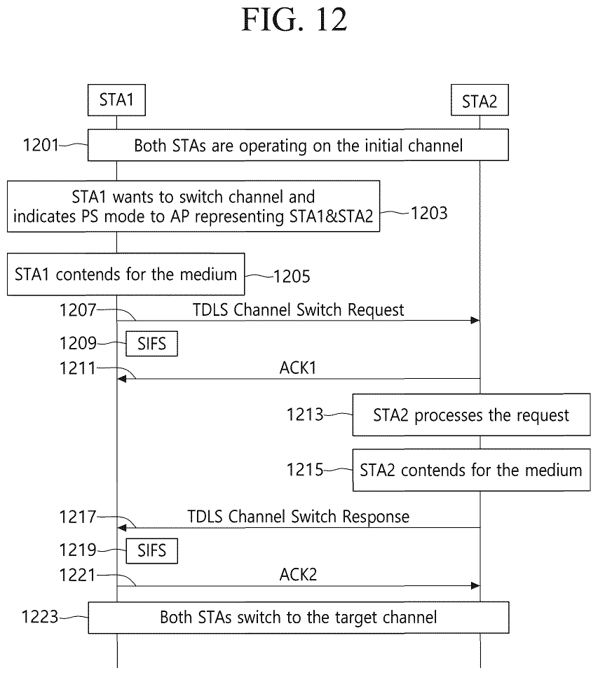

FIG. 12 illustrates a representative STA in TDLS channel switch in accordance with an embodiment. In 1201, both STAs, STA1 and STA2, are operating on an initial channel. In 1203, STA1 wants to switch channel and transmits a frame that indicates PS mode to the AP, where STA1 represents both STA1 and STA2. In particular, STA1 transmits the frame that indicates the PS mode to the AP before it contends the medium and sends the channel switch request frame. In 1205, STA1 contends for the medium.

STA1 may transition itself into the PS mode by transmitting a PPDU with the PM bit in the frame control field setting to 1. STA1 may also indicate to the AP the peer STAs, STA2, that are transitioning to the PS mode. The representative STA, STA1, can announce the representation behavior in the TDLS channel switch request frame so that the peer STAs, STA2, can have the knowledge of who is the representative and whether they have been transitioned to the PS mode or not. In 1207, STA1 transmits a TDLS channel switch request to STA2. In 1211, STA2 transmits an acknowledgement, ACK1, to STA1 an SIFS 1209 after the TDLS Channel Switch Request is received. In 1213, STA2 processes the request. In 1215, STA2 contends for the medium. In 1217, STA2 transmits a TDLS channel switch response to STA1. In 1221, STA1 transmits an acknowledgement, ACK2, to STA2 an SIFS 1219 after the TDLS Channel Switch Response is received. In 1223, both STAs switch to the target channel.

Table 1 provides information items that may be included in a TDLS channel switch request frame.

TABLE 1
Information items for enhanced TDLS channel switch request action field

| Information item | Description |
|---|---|
| Representative | This is to indicate to the peer that the TDLS channel switch request |
| behavior | initiator is the representative STA who helps to set all the peer STAs |
| | into the PS mode to AP. Such field may be encoded in 1 bit and can |
| | be set to 1 to indicate the channel switch request initiator is the |
| | representative STA, otherwise set to 0 to indicate the STA does not |
| | represent for the peer. |

In some embodiments, the representative STA may transmit a frame that includes the peer STA's information and indicates to the AP the transition to the PS mode by setting the PM bit in the frame control field to 1.

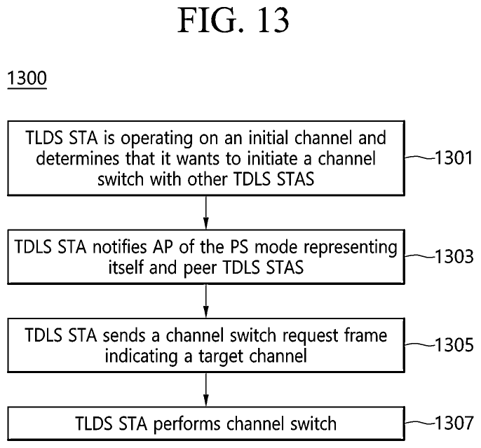

FIG. 13 illustrates an example flow chart of a process of a representative TDLS STA in PS mode in accordance with an embodiment. In operation 1301, the TDLS STA is operating on an initial channel and wants to initiate a channel switch with other TDLS STAs. In operation 1303, the TDLS STA notifies the AP (e.g., by transmitting a frame) of the PS mode representing itself and the peer TDLS STAs. In operation 1305, the TDLS STA sends a channel switch request frame indicating a request frame to a target channel. In operation 1307, the TDLS STA performs the channel switch. When the AP receives the PS mode frame from the representative TDLS STA, it may consider all of the STAs that the representative STA requests into the PS mode. Before the STA sends any PPDU or QoS null frame indicating the power save, the AP may continue to transmit to the STA if the AP contends the channel. Otherwise, the TDLS STA may not be involved in an active service period with the AP.

If the non-representative peer STA, which may also referr to as the represented STA herein, agrees to switch channels, the non-representative STA may not have to inform the AP of the PS mode since the representative STA has already done so. If the non-representative STA sends the channel switch response frame with the status code not set to SUCCESS, or if the TDLS channel switch response frame does not imply a channel switch because the STAs are already are on the requested channel, then the STA may indicate to the AP to keep active the service period.

In some embodiments, the represented peer STA may be selected as the representative STA to indicate the PS mode to the AP on behalf of another STA and itself. In particular, the TDLS STA who initiates to perform the channel switch and sends the channel switch request frame may not need to inform the AP of the other peer STA's transition to the PS mode since it may not know if the other peer STA may agree to switch or not. Thus, an STA that is responsible to respond to the channel switch frame may be the representative STA and thus may set the PS mode on behalf of both TDLS STAs.

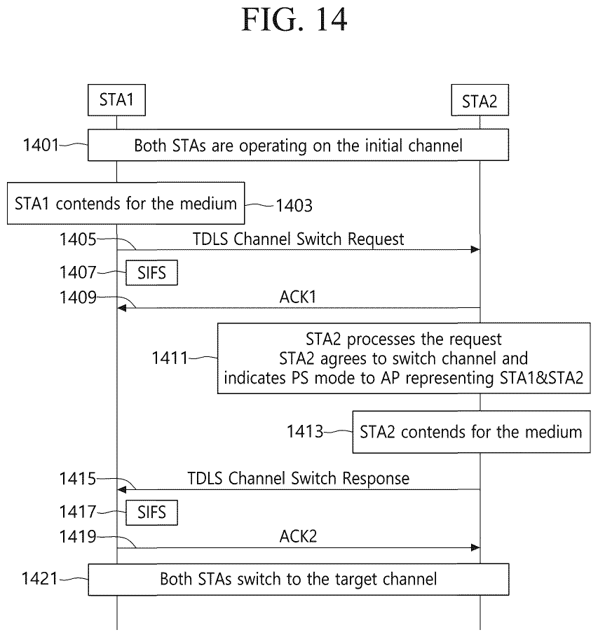

FIG. 14 illustrates representative STA (e.g., STA2) in TDLS channel switch in accordance with an embodiment. In 1401, both STAs, STA1 and STA2, are operating on an initial channel. In 1403, STA1 contends for the medium. In 1405, STA1 transmits a TDLS channel switch request frame to STA2. In 1409, STA2 transmits an acknowledgement frame, ACK1, to STA1 a short interframe space (SIFS) 1407 after the TDLS channel switch request frame is received. 1414. In 1411, STA2 processes the request, which includes STA2 agrees to switch channels and STA2 indicates PS mode to the AP where STA2 represents STA1 and STA2. In 1413, STA2 contends for the medium. In 1415, STA2 transmits a TDLS channel switch response frame to STA1 . . . . In 1419, STA1 transmits an acknowledgement frame, ACK2, to STA2 a SIFS 1417 after the TDLS channel switch response frame is received. In 1421, both STAs switch to the target channel.

Table 2 shows the information items for enhanced TDLS channel switch request action field that may be included in a TDLS channel switch request frame and/or a TDLS channel switch response frame.

TABLE 2
Information items for enhanced TDLS channel switch responder action field

| Information item | Description |
|---|---|
| Representative | This is to indicate to the peer that the TDLS channel switch responder |
| behavior | is the representative STA who helps to set all the peer STAs into PS |
| | mode to AP. Such field may be encoded in 1 bit and can be set to 1 |
| | to indicate the channel switch request responder is the representative |
| | STA, otherwise set to 0 to indicate the STA does not represent for the |
| | peer STAs. |

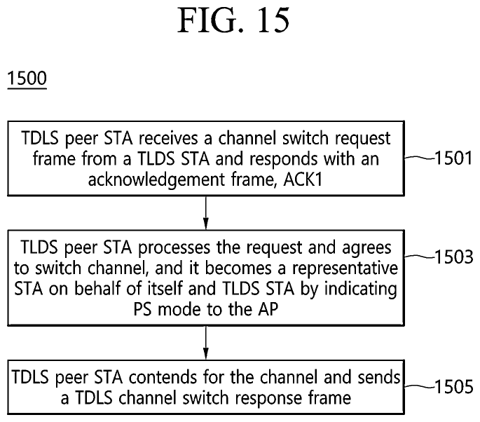

In some embodiments, the representative STA may include the peer STA's information and indicate the PS mode to the AP. FIG. 15 illustrates a flow chart of an example process for representative TDLS STA in PS mode. In operation 1501, a TDLS peer STA, STA2, receives a channel switch request frame from a TDLS STA, STA1, and responds with an acknowledgement frame, ACK. In operation 1503, the TDLS peer STA, STA2, processes the request, agrees to switch channels and becomes the representative STA on behalf of itself and STA1 and transmits a frame that indicates the PS mode to the AP. In operation 1505, the TDLS peer STA, STA2, contends for the channel and sends the TDLS channel switch response frame to STA1.

In some embodiments, the non-representative STA, which may be the channel switch initiator, may not need to inform the AP of the PS mode. The non-representative STA can maintain an active mode with the AP until the TDLS peer STA indicates the PS mode to the AP on behalf of the non-representative STA who initiated the TDLS channel switch. The non-representative STA may know its PS mode status via a channel switch response frame.

The processes described herein may have benefits under different conditions. First, if the TDLS channel switch is from the base channel, where the AP's channel is, to an off-channel, the channel switch initiator STA may be the representative STA for indicating PS for both STA1 and STA2, the benefit may be reduced overhead. However, a limitation may be that the AP may not be able to send low latency traffic to STA2 because it has been indicated in the PS mode by STA1. Thus, if the low-latency traffic is between the two TDLS peer STAs, then it may be beneficial to prevent the AP from transmitting any DL traffic to both peers. In some embodiments, it may be beneficial to protect low latency traffic from the AP to either STA1 and STA2, as such, STA1 or STA2 can also contend the channel to transmit UL traffic to AP before transmitting the channel switch response frame. Second, if the TDLS channel before channel switching is not at the AP's channel such that the switch is from an off-channel to a base channel or from an off-channel to another off-channel, in this case, there may be no need to inform the AP of the PS mode, because the STA is not on the base channel associated with AP. Thus, certain processes may not be required in these situations.

In some embodiments, a representative behavior may happen internally within a same device. In some embodiments, a bit may be specified to indicate that the representative behavior happens either for cross-device or for the same device. If the representative STA and the peer STAs are in the same device affiliated with the non-AP MLD, the representative STA may not need to repeat the upper MAC address of all peer STAs, since the upper MAC addresses are the same in the MLD, while the representative STA may provide a Link ID to the associated AP in the AP MLD. If the representative STA and the peer STAs are not in the same device, the STA may provide the information in an element, a frame, and/or A-control field to indicate the information for peer devices.

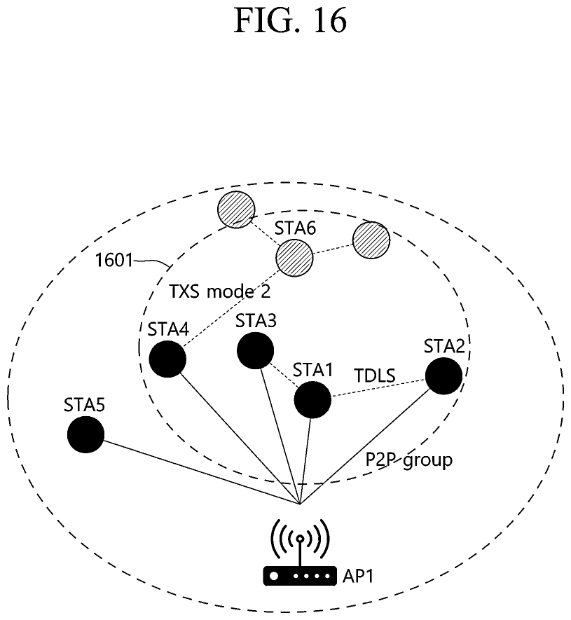

Some embodiments can provide a cross-device P2P unavailability indication in hybrid P2P networks. FIG. 16 illustrates co-existence of multiple P2P in a single BSS in accordance with an embodiment. In the single BSS with dense P2P scenarios illustrated in FIG. 16, AP1 is served as a single access point. The non-AP STAs which include STA1, STA2, STA3, STA4, and STA5, are associated with AP1. There may exist some STAs within the BSS that may not be associated with AP1, e.g., STA6. Multiple P2P transmissions with different types of protocols can co-exist in the BSS simultaneously. For example, STA1 and STA2 can form TDLS P2P links with the help of AP1; STA3 may transmit a TDLS response frame for a direct discovery; AP1 can also share the TXOP to STA4 using MU-RTS TXS mode 2, in which STA4 can perform P2P with STA6 or other STAs which use other non-IEEE P2P transmission protocols and may not associate with the AP. Accordingly, regardless of the protocol being utilized by the STAs, a larger P2P group 1601 can be formed for a better P2P use experience. In some embodiments, the representative STAs can help to announce the P2P activities to help the AP1 better manage the hybrid networks.

In some embodiments, one or more of the STAs associated with the AP may want to form and/or join P2P groups for itself and the TDLS Peer STAs whose TDLS Response frame has been received by the representative STAs. To efficiently notify the AP, the P2P group can have a representative STA to send a P2P group indication frame, for example, named as a cross-device PM indication frame, and/or a cross-device unavailability indication frame, which can notify the AP that one or more STAs are going to leave the AP for a P2P group and not only for the power saving mode.

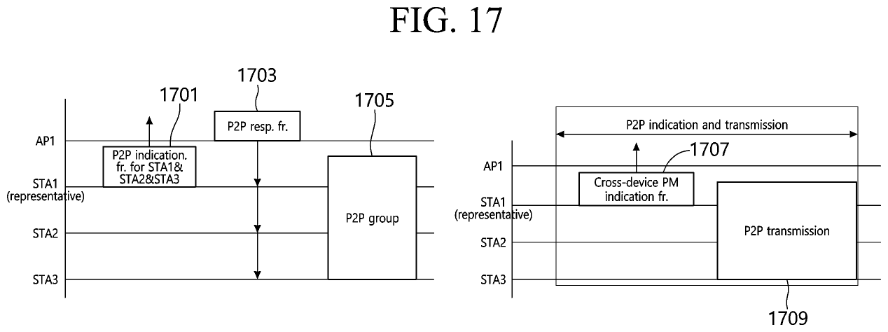

FIG. 17 illustrates a P2P group that includes three STAs and an AP. In the example of FIG. 16, STA1 can serve as a P2P group representative because STA1 is the TDLS initiator with STA2, and a receiver of STA3's response frame for discovery, and thus, STA1 can represent STA2 and STA3 to send a P2P group indication frame 1701 to the AP, AP1. Then the TDLS STA pairs may leave the AP for an amount of time of the PS mode but with a P2P purpose. The AP receiving the frame can identify the P2P activities and transmit a response 1703 to the STAs, e.g., STA1, STA2, and STA3 with a P2P group response frame 1705. STA1 may also be a representative for itself and the non-IEEE P2P peer STAs or with a group ID for the P2P group.

FIG. 17 illustrates an example of frame exchanges of a representative STA of P2P indication frame or cross-device unavailability indication frame in accordance with an embodiment. The P2P response frame may be presented or omitted. In particular, STA1 transmits a cross-device indication frame 1707 to AP1. STA1, STA2, and STA3 can communicate with P2P transmission 1709.

The representative STA behaviors can include the following. If the STA is the TDLS initiator, it may send a P2P indication frame to its associated AP representing other STAs that it has discovered and intended for forming and joining a P2P group. If the STA is not an TDLS initiator, it can indicate the intention of forming and/or joining the P2P group to the AP, and send the P2P group indication frame by itself on behalf of another non-IEEE P2P group. In the example of FIG. 16, STA4 can send a P2P group indication frame on behalf of itself and STA6 and associated nodes, to AP1. The two P2P groups may form separately or jointly based on their discovery.

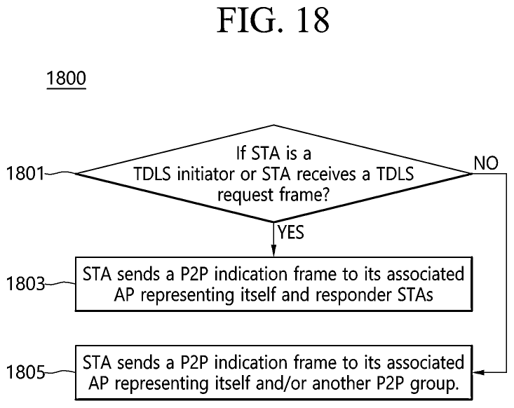

FIG. 18 illustrates an example flow chart of a process of a representative STA in accordance with an embodiment. In operation 1801, it is determined whether the STA is a TDLS initiator or if the STA receives a TDLS request frame. In operation 1803, if the STA is the TDLS initiator or the STA has received a TDLS request frame, the STA sends a P2P indication frame to its associated AP representing itself and those responder STAs. In operation 1805, If the STA is not the TDLS initiator nor the STA has not received a TDLS request frame, the STA sends a P2P indication frame to its associated AP representing itself and/or another P2P group.

The non-representative STA behavior can include the following. The non-representative STAs may first indicate to the representative STA's their preference in forming a P2P, e.g., sending TDLS response frame. In some embodiments, the non-representative STA may agree to be represented by the representative STA in a pre-negotiation procedure. Then these STAs may expect the AP's confirmation of P2P group response if they are associated with AP.

In some embodiments, the AP receiving the P2P group indication frame from the P2P group representative STA can support the P2P group by responding with a P2P group indication response frame to all the STAs whom the initiator STA requires. The AP may also set or consider the STAs into power saving mode. The AP may also reject the indication frame for some STAs with one or more reasons. For example, if any urgent DL PPDUs are going to happen to those STAs, or the addresses of the STAs are incorrect, among other reasons. The AP receiving the P2P group indication frame from an STA that is not a P2P group initiator, may also respond with a P2P group indication response frame.

The P2P group indication frame and P2P group indication response frame can include at least one or more of the information items specified in Table 3 and Table 4 below, respectively. The P2P group indication frame can be a periodic indication frame or an aperiodic-based frame. In the BSS networks that all the STAs are associated with the AP, the peer STAs may agree to be scheduled to go to off-channel or other channels for P2P, and leave the AP for a period of time. The frame may include the information listed in Table 3 and Table 4 to keep the AP updated. The representative STA may maintain the role while the peer STAs may stay, join, or leave the P2P group. In some embodiments, the P2P group indication frame may need to periodically update the user information list and number of peer STAs, among other information in the frame.

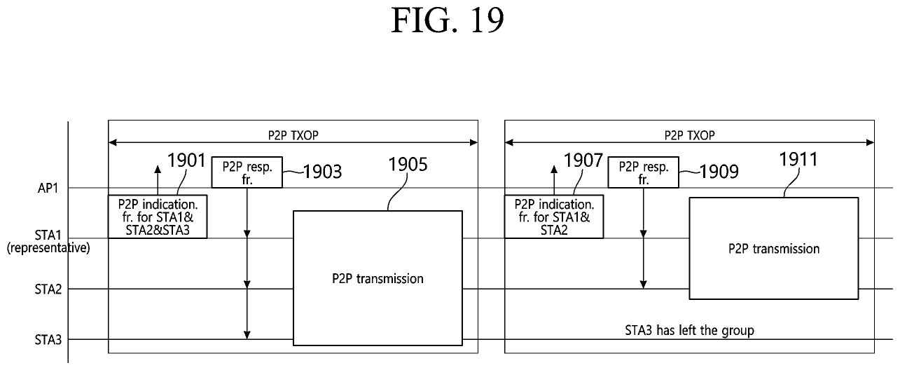

FIG. 19 illustrates periodic frame exchanges in BSS networks in accordance with an embodiment. FIG. 19 illustrates a P2P group that includes three STAs and an AP. In the example of FIG. 19, STA1 can serve as a P2P group representative. STA1 can represent STA2 and STA3 to transmit a P2P indication frame 1901 to the AP, AP1. AP1 receives the frame and can identify the P2P activities and transmits a P2P response frame 1903 to STA1, STA2, and STA3. STA1, STA2 and STA3 can have P2P transmission 1905. At a later time, STA3 leaves the P2P group and STA1 transmits a P2P indication frame 1907 for STA1 and STA2 to AP1. AP1 transmits a P2P response frame 1909 to STA1 and STA2. STA1 and STA2 can perform P2P transmission 1911.

For ad-hoc networks that one or more STAs may be associated with the AP while some peer STAs may not be associated with the AP (e.g., STA6 in the example of FIG. 16), the representative STA may need to inform the AP in the PS mode on behalf of the peer STAs who are associated with the AP and the P2P group who may not be associated with AP. At the same time, the representative STA may need to update the information to all the peer STAs who are not associated with the AP regarding the necessary information such as RU and wakeup schedule. The update may be another frame from the representative STA to the peer STAs that are not associated with AP.

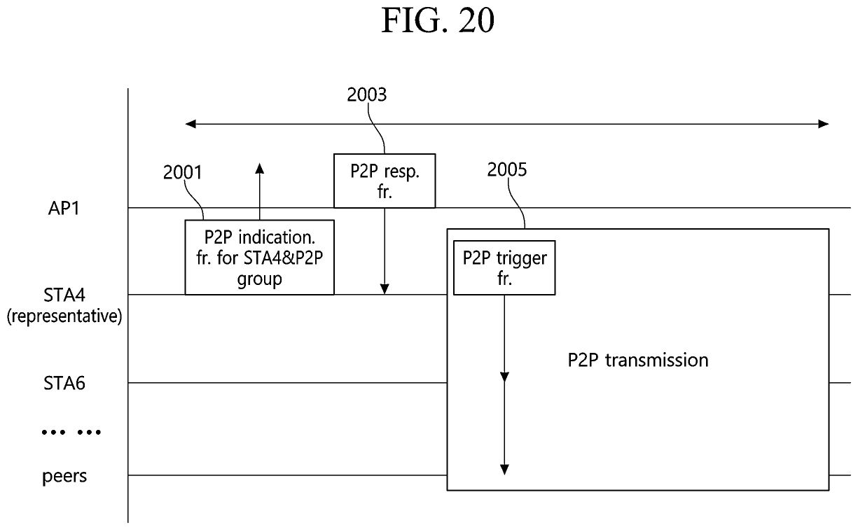

FIG. 20 illustrates aperiodic frame exchanges in BSS networks in accordance with an embodiment. In FIG. 20, STA4, which is the representative STA, can transmit the P2P group indication frame 2001 indicating to AP1 that STA4 and other represented peer STAs are in P2P mode. AP1 can transmit a P2P response frame 2003 to STA4. STA4 can transmit a P2P trigger frame 2005 to STA6 and peer STAs. In some embodiments, a beacon or a trigger frame can be modified to broadcast to the peer STAs. For example, STA4 may transmit the frame to STA6 and the other peer STAs that are not associated with the AP, or not with the same AP. The frame may be to notify the peer STAs about the representative role, buffer states, RU allocation, among other information similar to the information items in Table 3.

TABLE 3
Information items that can be presented in P2P group
indication frame by the representative STA

| Information item | Description |
|---|---|
| Representative | An information item that indicating the STA is a representative STA |
| information | for itself only or include another TDLS groups or non-IEEE groups. |
| Number of peer STAs | An information item that indicates the number of peer STAs in the |
| | BSS. |
| P2P group address | An information item that can be used to address the P2P group. |
| User info list | The representative STA can help to provide other TDLS peer STAs' |
| | information; non-IEEE group's ID. |
| P2P traffic pattern | An indication on whether the P2P traffic is periodic or aperiodic. e.g., |
| info | this can be a bit that is set to 1 to indicate that the traffic stream is |
| | periodic and set to 0 if it is not periodic. |
| P2P transmission | A P2P transmission time duration requests by the representative STA |
| duration | for P2P activities. If the transmission is aperiodic, and the duration |
| | time is not specified in the field, the window is set 0. Otherwise, it |
| | should indicate the size of the window. |
| RU information | An information item to indicate which transmission resource the P2P |
| | transmission will operate on. e.g., base-channel, off-channel |
| | information, among others. |
| Wakeup schedule | The wakeup schedule element includes information regarding the |
| | periodic wakeup schedule for the PS mode. Outside of the wakeup |
| | service period, representative STA should indicate the representative |
| | STA and the peer STAs in PS mode for the P2P transmission window. |
| Group sleep schedule | The sleep schedule element includes information regarding the |
| | periodic sleep schedule for the unavailability of P2P activities. |
| | During the group sleep schedule, the AP may avoid interrupting the |
| | P2P STAs during those P2P time slots. |
| P2P roaming | An information item that indicates the group roaming to AP by |
| indication info | representative STA. |
| Buffer states report | An information item that the representative STA may report the |
| | buffer indicating the P2P transmission. |

TABLE 4
Information items that can be presented in P2P group indication response frame

| Information item | Description |
|---|---|
| RU allocation | The AP can announce the RU allocation for the P2P group. |
| Wakeup schedule | The wakeup schedule element includes information regarding the |
| | periodic wakeup schedule for the PS mode. |
| Group sleep schedule | The sleep schedule element includes information regarding the |
| | periodic sleep schedule for the unavailability of P2P activities. |
| | During the group sleep schedule, the AP may avoid interrupting the |
| | P2P STAs during those P2P time slots. |

In some embodiments, when there is AP traffic and P2P traffic, there are various ways the P2P STAs can make decisions about the P2P time-frequency domain schedule. In some embodiments, there may be one P2P STA, the representative STA, that is making the decision based on the requirements of the application that triggers the P2P service, and this P2P STA may need to broadcast to all other P2P STAs about schedule so that the P2P STAs can be prepared to transmit and/or receive the P2P traffic during the scheduled time slots. This may be applicable to Wi-Fi Direct and/or Wi-Fi Aware.

In some embodiments, the application layer can set a predefined schedule for the P2P STAs. Since all P2P STAs may be activated by the same app, the predefined schedule may already be set to the P2P STAs without the need for over-the-air signaling.

In some embodiments, when multiple STAs initiate multiple TDLS P2P links but in the same BSS, each of the TDLS initiator STAs can send the P2P indication frame representing its own peers to notify the AP for forming a P2P group. The frame can be in different time or frequency resources.

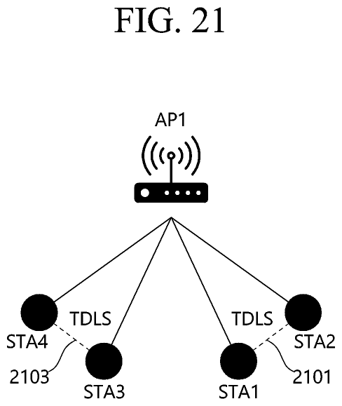

FIG. 21 illustrates multiple TDLS representative STAs in accordance with an embodiment. In particular, AP1 is associated with several STAs, including STA1, STA2, STA3 and STA4. STA 1 and STA2 have a TDLS P2P link 2101, and STA3 and STA4 have a TDLS P2P link 2103.

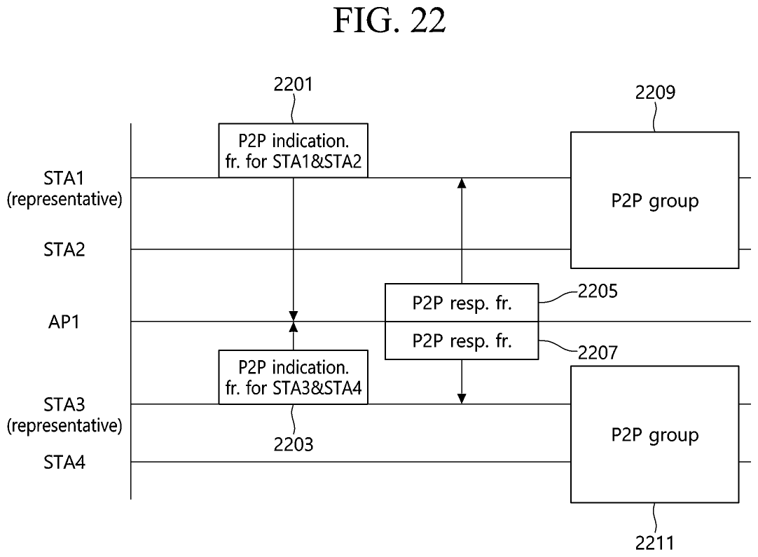

FIG. 22 illustrates frame exchanges of multiple representative STAs in accordance with an embodiment. In particular, AP1 may be associated with several STAs, including STA1, STA2, STA3, and STA4. STA1 is a representative STA for STA1 and STA2 and STA3 is a representative STA for STA3 and STA4. STA1 can transmit a P2P indication frame 2201 to AP1, where STA1 represents STA1 and STA2. STA3 can transmit a P2P indication frame 2203 to AP1, where STA3 represents STA3 and STA4. AP1 can transmit a P2P response frame 2205 to STA1, and a P2P response frame 2207 to STA3. STA1 and STA2 can form a P2P group 2209, and STA3 and STA4 can form a P2P group 2211.

In some embodiments, an STA may indicate the representative needs and capabilities to its neighboring STA peers, to show the willingness and preference of representative behaviors. STAs may negotiate the role and whichever STA has the highest preference may become the representative STA. After the negotiation, each STA may inform the AP about the negotiation outcome on its role and capabilities.

In some embodiments, the AP may select a representative STA by analyzing the request frames from the peer STAs. After the AP has analyzed and identified a best candidate STA, the AP can announce the outcome of the representative roles. The STAs can then acknowledge the results.

In some embodiments, some STAs may become the representative STA if they initiate the P2P service. For example, the TDLS initiator may become the representative STA and indicate the PS mode on behalf of other peer STAs. In some embodiments, a group owner in, for example, WiFi direct may become a representative STA.

In some embodiments, a purpose of having the representative STA, or anchor (master) STA, may be to form a peer group, so that the communications with the AP can be operated by one STA.

In some embodiments, an STA that is willing to be represented (e.g., the represented STA) may commit to the representative STA for communicating with the AP (e.g., PS, roaming, among other communications). The representative STA should not interfere with a transmission from the AP to a peer STA. Various benefits of using a represented STA may include power saving, representative functionalities support such as P2P support and roaming as a group, and a peer STA may not have to contend the channel since the representative STA may notify the traffic and may share the TXOP to the represented peer STA. The represented STA may connect with the AP again when needed.

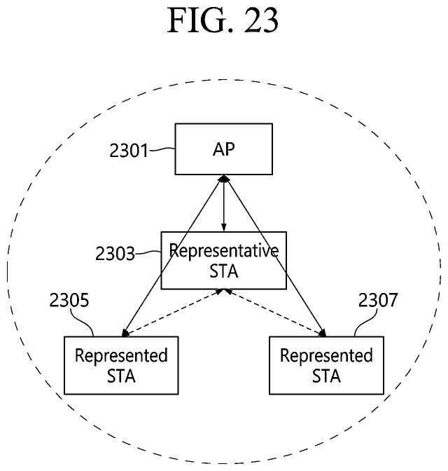

FIG. 23 illustrates a topology of an STA coordination with a 1:N group in accordance with an embodiment. In particular, FIG. 23 illustrates a two-layer 1:N group, in which there is one AP, AP 2301, in the BSS, and number N of STAs around. N may be greater than or equal to two to maximize the representative behavior benefits. As illustrated in FIG. 23, there is an AP 2301, one representative STA 2303, and two represented STAs, represented STA 2305 and represented STA 2307. In some embodiments, a representative group may be formed with one representative STA and no represented STA nearby, which can be seen as a legacy scenario.

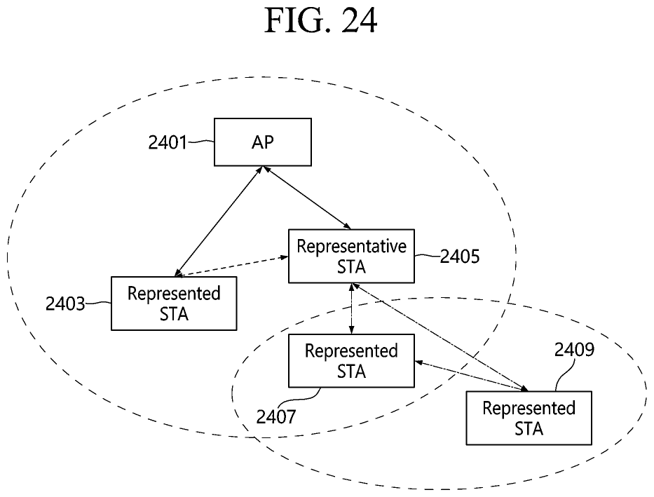

FIG. 24 illustrates a topology of the STA coordination of a 1:N:M group in accordance with an embodiment. FIG. 24 illustrates a three-layer 1:N:M group, in which the third-layer STAs may not have to be associated with the AP while it has a connection with one STA associated with the AP. In particular, AP 2401 is associated with representative STA 2405, represented STA 2403, represented STA 2407. Furthermore, representative STA 2405 is associated with represented STA 2409, which is not associate with AP 2401.

In some embodiments, the representative STA may be determined via peer STAs. Some embodiments may include four phases. A first phase may be a discovery procedure. During this phase, the STAs may send beacons or frames to discover other STAs and record the STAs who are UHR STAs with such need and capability, and who has the highest preference to become the representative.

In a second phase, the STAs may indicate the representative preference or willingness, and negotiate and confirm the roles and services by exchanging negotiation frames amongst the STAs.

During a third phase, the AP may be informed by one or more STAs about the outcome of the negotiation. Each STA may notify the AP about its role and capabilities.

During a fourth phase, the AP may send a confirmation to the STAs. The confirmation from the AP may be to acknowledge the representative group's formation and their roles.

In some embodiments, a discovery procedure or mutual discovery procedure may provide a scheme for the STA to discover the neighboring UHR/UHR+ peers supporting representative needs and capabilities, and indicate the willingness and preference of representative behaviors. Different types of frames can be specified for use as the discovery frames.

In some embodiments, each STA may send a beacon frame. STAs can discover each other by receiving beacons or probe response frames. When the STA broadcasts the beacon frame, it may include the information in Table 5 into the beacon frame. Among the information items, the preference rank may consider integrating a set of factors into one element such as the degree of the network graphic topology (STA who may discover more STAs including those may not be associated with AP), the channel statistic with AP, battery status, other devices capabilities, among other factors. The STAs may decide itself for the role based on the rank indicated in the received beacons. Whoever achieves the highest value of the preference rank may become the anchor or representative STA. Some embodiments may calculate a rank denoted as Rank_repSTA given by:

Rank_{repSTA}=f₁(RSSI)+f₂(Representative Preference)+Random Factor
in which f₁, f₂ are functions of variable Received Signal Strength Indicator (RSSI) and representative preference, among other factors. The representative preference may denote the degree to which the STA intends to be a representative. The STA may calculate a rank for itself and compare the ranks of other STAs that it receives with itself. An STA that can become a representative STA may have the highest rank in the group. Those STAs that may not be associated with the AP, or are currently not able to be the representative STA can set the Rank_repSTA as zero. If an STA does not support the representative capability, it may also ignore the frame.

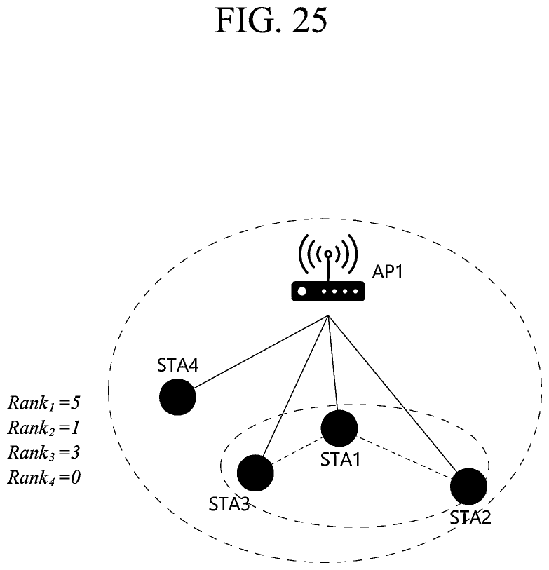

FIG. 25 illustrates an example topology for selecting a representative STA in accordance with an embodiment. In particular, AP1, can be associated with several STAs, including STA1, STA2, STA3, and STA4. STA1 can be a representative STA representing STA2 and STA3.

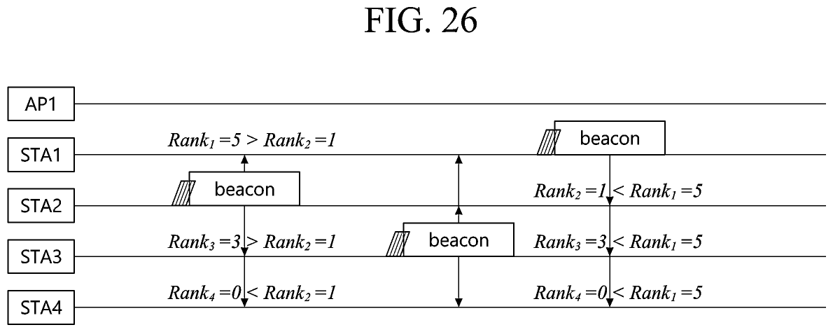

FIG. 26 illustrates discovery beacons in accordance with an embodiment. The number of the rank in FIG. 26 is an example, the real value may depend on implementation and design. A random factor may be utilized to reduce the probability of the same rank values of the devices. If the rank values of two devices are the same, a tie-breaker may be included in the negotiation frame for two-user case. As illustrated STA2 broadcasts a beacon frame to AP1, STA1, STA3 and STA4, which beacon frame indicates the calculated ranks (Rank_repSTA) of: Rank₁=5, Rank₂=1, Rank₃=3, and Rank₄=0, and each STA can compare its own rank with the received beacon. STA3 broadcasts a beacon frame to AP1, STA1, STA2, and STA4. STA1 transmits a beacon frame to AP1, STA2. STA3. STA4. Accordingly, the STAs can broadcast beacon frames amongst themselves in order to determine the representative STA and the represented STAs for the group.

TABLE 5
information items included in the mutual discovery frame

| Information item | discerption |
|---|---|
| Representative | An information item that indicates the STA is a |
| capability | UHR/UHR + STA with representative or represented |
| | capability, which means it can support the peers to be |
| | a representative by giving right to the STA based on |
| | specific service; or it can become a representative |
| | talking to AP on behalf of the other peer STAs. |
| Peer STA | An indication on whether the STA has any connection |
| information | with other peers or groups. For example, a STA may |
| | also connect with a P2P group outside of the AP. This |
| | can be one-bit information, if the STA has a |
| | connection with other P2P groups, set the bit to 1, if |
| | not, set the bit to zero. |
| Number of peers | If the peer STA information shows that the STA has |
| | another group connected, e.g., the bit of peer STA |
| | information is 1, this information item may indicate |
| | the number of the peers. Otherwise, set to zero. |
| Preference Rank | An information item that is calculated by the STA, |
| | including RSSI and representative preference, among |
| | other, which shows the preference of becoming a |
| | representative STA. |
| RSSI information | An information item that indicates the RSSI between |
| | the STA and AP. |
| Representative | An item shows the degree to which the STA wants to |
| Preference | be a representative based on implementation. |
| Battery status | An information item that indicates the battery status of |
| | the STA, if the STA has a very low power and will be |
| | in save mode soon after a threshold, the Rank may |
| | consider this has a low preference to become a |
| | representative STA. |
| Latency traffic | An information item that may indicates the latency |
| indication | traffics. |
| Buffer status | An information item that indicates the buffer status of |
| | the STA. |

When the STA sends a probe response frame, the neighboring STAs can be informed that it is capable to participate Multi-STA coordination, e.g., representative behaviors. Therefore, the STAs may record the numerical value of Representative Preference which are the number of neighboring peers who are hearable and has the representative/represented capability.

Some embodiments may send a modified Access Network Query Protocol (ANQP)-element request/response frame to discover peers via a direct link between peers. An STA may use ANQP to retrieve peer STA's information such as TDLS Capability (e.g., InfoID 270 in Table 6 below), neighbor report for APs (e.g., 272). To indicate the representative capability, some embodiments may use for example, the reserved InfoID=284. The peer information may be indicated in a TDLS capability ANQP-element. For UHR peers, the capability for enhanced peer report (e.g., more peers, indicating number of peers, among other information) can be extended together with the representative capability.

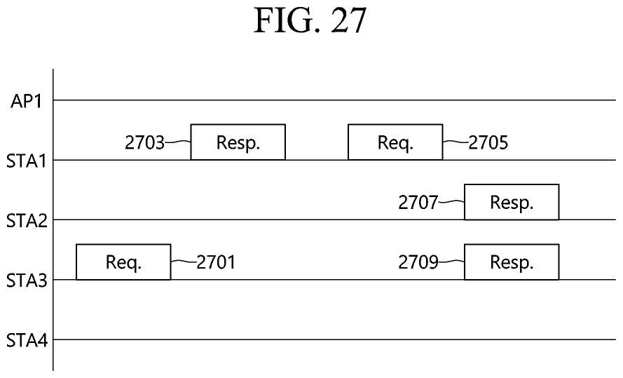

FIG. 27 illustrates a discovery request and response frame exchange in accordance with an embodiment. As illustrated STA3 can transmit a request frame 2701, STA1 can transmit a response frame 2703 and request frame 2705, STA2 can transmit a response frame 2707, and STA3 can transmit a response frame 2709.

TABLE 6
information items included in the modified
request and response frames

| | | ANQP-element |
|---|---|---|
| ANQP-element name | InfoID | type |
| Representative capability | 284 | Q, S |
| Peer report | 270/275 | Q, S |
| (enhanced TDLS | | |
| capability) | | |
| Preference RANK | 285 | Q, S |

peer report (enhanced TDLS Capability ANQP-element)

| | Info ID | Length | Representative capability |
|---|---|---|---|
| Octets: | 2 | 2 | variables |

In some embodiments, the discovery frame may be a modified TDLS response frame or a service discovery frame to advertise and discover services offered by neighboring STAs. The information listed in these frames may include those listed in Table 6.

In some embodiments, a negotiation procedure may be used by a candidate representative STA to negotiate and confirm with its peer STAs for the request service information.

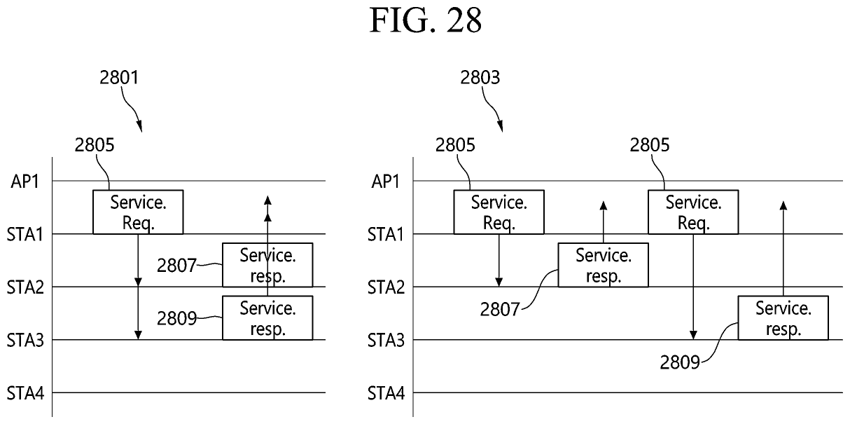

FIG. 28 illustrates a service negotiation frames exchange in accordance with an embodiment. The frame exchange may use the topology of FIG. 25. FIG. 28 illustrates two cases for the frame exchange, the left 2801 may be realized by OFDMA, while the right side 2803 may be contention-based channel access. In this example, after the discovery procedure, STA1 may achieve the highest rank and representative preference. Thus, STA1 starts the service request procedure by transmitting the service request frame 2805 to the peer STAs, STA2 and STA3, who may indicate the representative behavior and capabilities or needs during the discovery procedure. The STA receiving a service negotiation request frame may examine the received information and respond with a service negotiation response frame, in particular STA2 transmits a service negotiation response frame 2807 to AP1, and STA3 transmits a service negotiation response frame 2809 to AP1. Then the peer STAs, STA2 and STA3, may respond to STA1 in confirming the representative capabilities and services to handover the communication with AP1 to STA1 in next few TXOP or slot, which indicates a status of success.

The peer STA may also decline the negotiation request frame for any reason and reply with a negotiation response frame with status code set to Failure or Request_Declined. After receiving the service response frame at STA1, STA1 can start the representative service to communicate to AP1 on behalf of the other STAs with a success status response. The information items in the service request frame and response frame may include the information listed in Table 7 and Table 8.

TABLE 7
information items included in the service negotiation request frame

| Information items | Description |
|---|---|
| Representative | An information item that is calculated by the |
| Rank | STA, including RSSI, its preference of |
| | becoming a representative STA (based on |
| | implementation), among others. |
| Operating channel | The information items may include a |
| | preferred/suggested operating channel. |
| Channel lists | Indicate the channels that the STA can support |
| | as base and off-channels if it becomes a |
| | representative STA. |
| Configuration | The maximum time that the STA needs before |
| timeout | receiving the response frame. Otherwise, a |
| | retransmission may be needed. The |
| | retransmission time is also limited. |
| P2P capability | The P2P capability indicates the characteristics |
| | and the capability of forming a P2P Group with |
| | representative STA support |
| Roaming capability | The roaming capability indicate the |
| | characteristics and the capability of roaming as |
| | a group with representative STA support |
| Power save | The power save indication is to be in power |
| indication | save mode as a group |
| Reserve | More capability with the representative STA |
| | behavior can be developed in the Reserved |
| | information. |

TABLE 8
information items included in the
service negotiation response frame

| Information items | Description |
|---|---|
| Status | An information item that indicates its intent to |
| | become a represented STA. If the STA is |
| | willing to be the represented STA, the Status is |
| | SUCCESS; otherwise, the status is Request_{—} |
| | Declined or Failure. |
| Representative | An information item that is calculated by the |
| Rank | STA, including RSSI, its preference of |
| | becoming a representative STA (based on |
| | implementation), among others. |
| Operating channel | The operating channel could indicate the |
| | intended operating channel of the representative |
| | STA. And it could be one of the channels from |
| | the Channel Lists. |
| Channel lists | It may include channels from the Channel List |
| | information in the service negotiation request |
| | frame. Or it may be determined independently. |
| Configuration | The maximum time that the STA needs before |
| timeout | receiving the response frame. Otherwise, a |
| | retransmission may be needed. The |
| | retransmission time is also limited. |
| P2P capability | Reserved. It may indicate to support the |
| | behavior. |
| Roaming capability | Reserved. It may indicate to support the |
| | behavior. |
| Power save | Reserved. It may indicate to support the |
| indication | behavior. |

In some embodiments, in phase 2, in two peer STA scenarios, a three-way negotiation may also happen after a TDLS response discovery. The negotiation request and response may include similar information included in Table 7 and Table 8. The difference may be that the two peer STAs may need to share and compare the representative rank and preference during the procedure, and thus, another negotiation confirmation may be needed to complete the procedure.

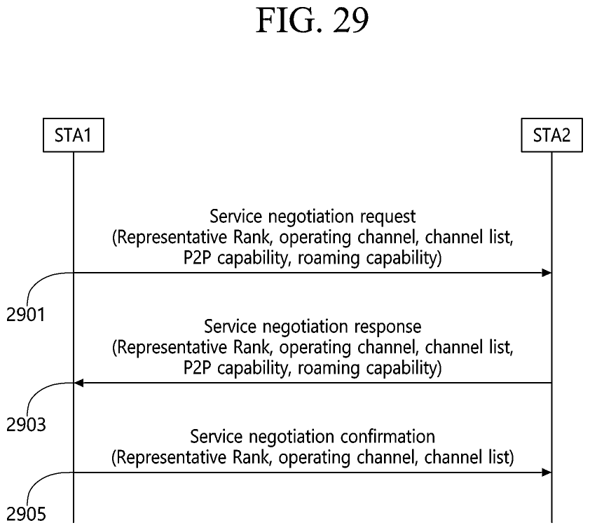

FIG. 29 illustrates a three-way service negotiation frame exchange in accordance with an embodiment. In 2901, STA1 can transmit a service negotiation request frame to STA2, where the request frame can include a representative rank, operating channel, channel list, P2P capability, roaming capability, among other information. In 2903, STA2 can transmit a service negotiation response frame to STA, where the response frame can include a representative rank, operating channel, channel list, P2P capability, roaming capability, among other information. In 2905, STA3 can transmit a service negotiation confirmation frame to STA2, where the confirmation can include the representative rank, operating channel, and channel list, among other information.

Some embodiments can include a third phase where the STA informs the AP about the negotiation outcome. In particular, after the STAs discover one another, and negotiate the roles, the STAs may need to inform the AP about their negotiation outcome, including their roles and capabilities. A service report frame from the representative STA to the AP may be transmitted to indicate the representative characteristics, including the roles and users of the representative STA and represented STAs, the service duration, the operating channels and modes, and the capability of the representative STA, among other information. In some embodiments, direct communication may be needed from the represented STAs to the AP to handover the control to the representative STA. The information items that can be included in a service report frame are listed in Table. 9.

TABLE 9
information items included in the service report frame to AP

| Information items | Description |
|---|---|
| Roles | An information item that indicates the |
| | representative and represented roles of the |
| | STAs. For example, a bit can be designed to |
| | indicate for the role. 0 bit means represented |
| | STA, bit 1 means representative STA. |
| User Info List | An information indicates the information list of |
| | the represented STAs. The user info list can be |
| | presented if the bit in Roles is 1. |
| Operating channel | The intended channel or the preferred channel |
| | that the representative and represented STAs are |
| | operating on. |
| Channel lists | It may include channels that the represented |
| | group are preferred or can support. |
| Transmission | A time duration requested by the representative |
| duration | STA for its representing group. |
| P2P capability | An item that indicating P2P group transmission |
| | that may leave AP for a period of time. |
| Roaming capability | An item that indicating roaming as a group to |
| | AP. |
| Power save | An item that indicating power saving mode as a |
| indication | group to AP. |
| T2LM mapping | An information item that STA may update their |
| | traffic. |
| MLO operation | An information item that STA may update their |
| update | MLO operations such as EMLSR, EMLMR |
| | modes etc. |

Some embodiments can include a fourth phase where there may be a confirmation from the AP. In particular, a confirmation frame may be transmitted from the AP to one or more STAs to confirm the representative group's formation and their roles. The confirmation frame from the AP to each STAs may be to confirm the reception from the representative group. The confirmation frame may include information from Table 9. Each reporting frame to the AP and confirmation from the AP may be to prevent a spurious device from sending a malicious frame to the AP indicating all the STAs are within the suspicious group.

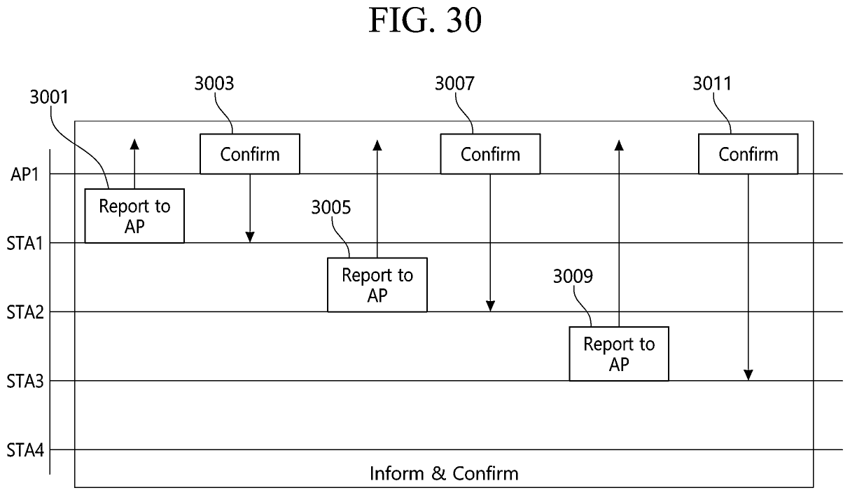

FIG. 30 illustrates a frame exchange for phase 3 and phase 4 in accordance with an embodiment. In particular, STA1 transmits a service report frame 3001 to AP1 and AP1 transmits a confirmation frame 3103 to STA1, STA2 transmits a service report frame 3005 to AP1 and AP1 transmits a confirmation frame 3007 to STA2, and STA3 transmits a service report frame 3009 to AP1 and AP1 transmits a confirmation frame 311 to STA3.

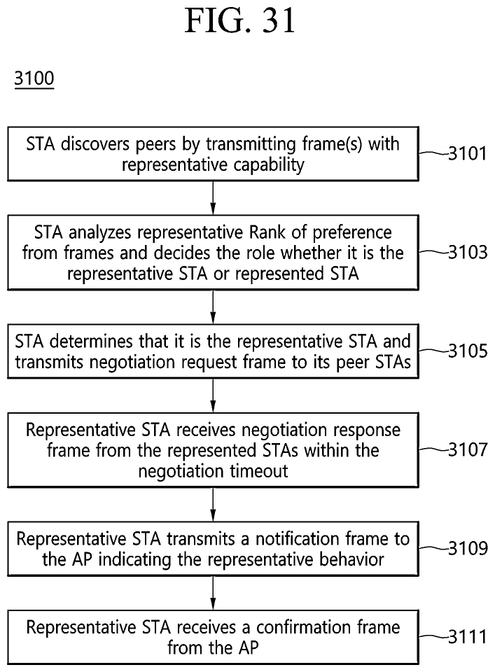

FIG. 31 illustrates a flow chart of an example process at a representative STA in accordance with an embodiment. In operation 3101, the STA discovers peers by transmitting frames (e.g., beacon, probe request, probe response, AQNP-element frames, or enhanced TDLS frames) with a representative capability. In operation 3103, the STA analyzes the representative Rank of preference from the frames and decides whether it is the representative STA or represented STA. In operation 3105, the STA determines it is the representative STA and transmits a service negotiation request frame to its peer STAs. In operation 3107, the representative STA receives the negotiation response frame from the represented STAs within the negotiation timeout. In operation 3109, the representative STA transmits a notification frame to the AP indicating the representative behavior. In operation 3111, the representative STA receives a confirmation from the AP.

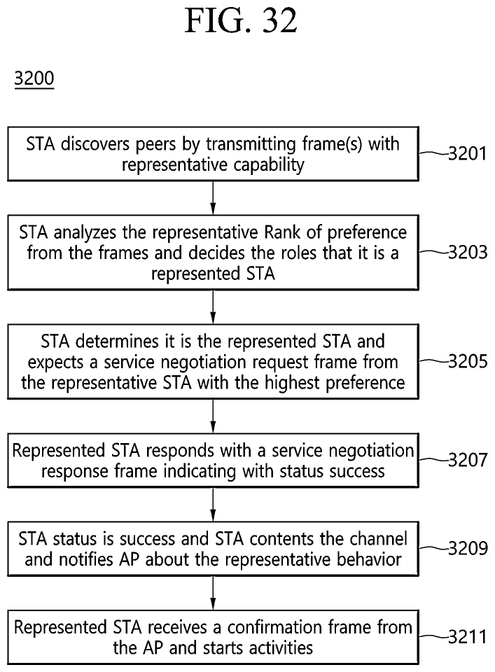

FIG. 32 illustrates a flow chart of an example process at a represented STA in accordance with an embodiment. In operation 3201, the STA discovers peers by transmitting frames (e.g., beacon, probe request, probe response, AQNP-element frames, or enhanced TDLS frames) with a representative capability.

In operation 3203, the STA analyzes the representative Rank of preference from the frames and decides whether it is the representative STA or represented STA. In operation 3105, the STA determines it is the represented STA and it may expect a service negotiation request frame from the representative STA with the highest preference. In operation 3207, the represented STA responds with a service negotiation response frame, indicating a status success or decline. In operation 3209, the STA determines the status is success and contends the channel and notifies AP about the representative behavior. In operation 3211, the represented STA receives a confirmation frame from the AP and may start activities.

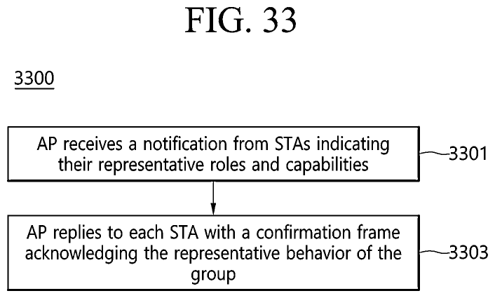

FIG. 33 illustrates a flow chart of an example process at an AP in accordance with an embodiment. In operation 3301, the AP receives a notification from STAs indicating their representative roles and capabilities. In operation 3303, the AP replies to each STA with a confirmation frame acknowledging the representative behavior of the group.

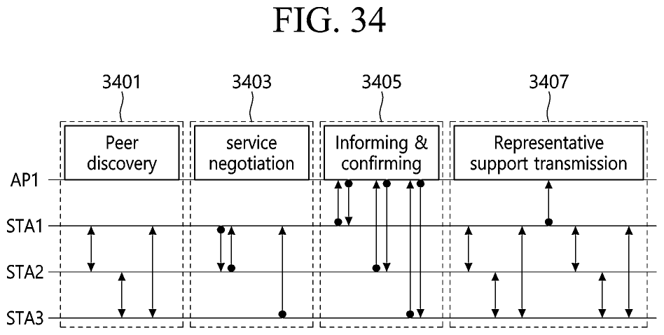

FIG. 34 illustrates an example frame exchange in four phases in accordance with an embodiment. As illustrated, a first phase of peer discovery 3401, the STAs (STA1, STA2, and STA3) may send beacons or frames to discover other STAs and record the STAs who are UHR STAs with such need and capability, and who has the highest preference to become the representative.

In a second phase of service negotiation 3403, the STAs may perform service negotiation 3403 to indicate the representative preference or willingness, and negotiate and confirm the roles and services by exchanging negotiation frames amongst the STAs.

During a third phase of informing and confirming 3405, the AP may be informed by STAs (STA1, STA2, and STA3) about the outcome of the negotiation. Each STA may notify the AP about its role and capabilities and the AP may send a confirmation to the STAs. The confirmation from the AP may be to acknowledge the representative group's formation and their roles.

During the fourth phase of representative support transmission 3407, the STAs can transmit amongst each other and the representative STA, here STA1, can communicate with AP1 on behalf of the represented STAS, STA2 and STA3.

Some embodiments may determine the roles of the STAs with the assistance of the AP. In some embodiments, the representative STA may be determined by the AP. Some embodiments may include three phases. A first phase may include a mutual discovery procedure, which can be similar to a first discovery phase described herein. One or more of the STAs may indicate their intention of selecting a candidate via the AP. If there is a conflict that some STAs prefer the assistance from the AP and some may not indicate the preference of the assistance from the AP. Accordingly, some embodiments may respect those STAs with AP-assisted need.

TABLE 10
information items included in the mutual discovery frame

| Information | |
|---|---|
| item | discerption |
| AP | An information item that indicates the roles can be |
| assistance | decided with the help of AP. |

Some embodiments can include a second phase where the AP-assisted representative STA selection is considered. After the discover steps, the STAs can report their results to the AP and let the AP select a best candidate. In some embodiments, the AP may then collect a set of representative requests with their preference and capabilities.

Some embodiments may include a third phase where the AP may announce the results and confirm with the STAs. The AP may help to select a best candidate as the representative STA and announce the roles of the STAs. In some embodiments, the AP may select the representative STA as described herein by comparing and analyzing the Preference Rank in the service request frames from the STAs. The service request frame may include the information items such as the service request frame in phase 2 described herein. If one or more STAs show the same rank, the AP can ask for a refresh of a random factor or randomly select an STA. After the AP has analyzed the best candidate, the AP can announce the outcome of the representative roles to the STAs. In some embodiments, the frame may include the information items such as the confirm frame in the fourth phase. Then, the STAs can acknowledge the results.

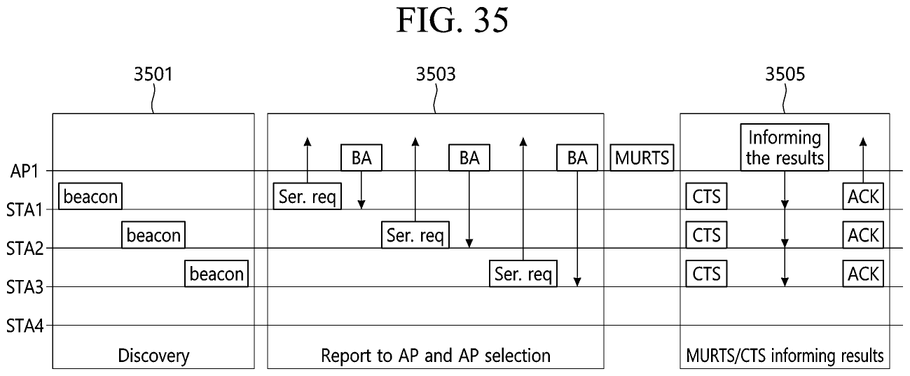

FIG. 35 illustrates an example of a frame exchange in three phases after discovery in accordance with an embodiment. In the first phase, the discovery phase 3501, STA1, STA2 and STA3 can broadcast beacon frames among each other. The second phase 3503, the STAs can report to the AP and the AP can assist in selecting the representative STA. In particular, after the discovery phase, the STAs can report their results to the AP and let the AP select a best candidate. In some embodiments, the AP may then collect a set of representative requests with their preference and capabilities. During a third phase 3505, the AP announces the results and confirms with the STAs.

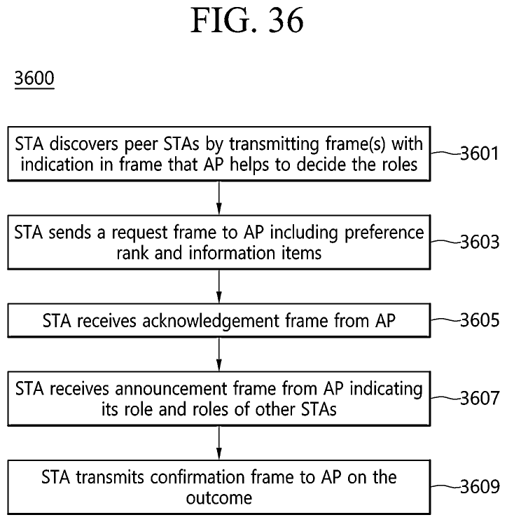

FIG. 36 illustrates a flow chart of an example process at an STA side in accordance with an embodiment. In operation 3601, an STA discovers peers by transmitting frames and indicating in the frame to help an AP decide the roles.

In operation 3603, the STA sends a request frame to the AP including a preference rank and various information items (e.g., Table 7).

In operation 3605, the STA may receive an acknowledge frame from the AP.

In operation 3607, the STA may receive an announcement from the AP indicating its role and the roles of other STAs.

In operation 3609, the STA confirms with the AP the outcome.

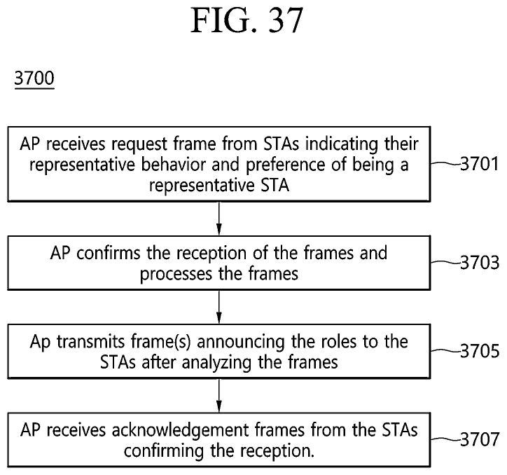

FIG. 37 illustrates a flow chart of an example process at an AP side in accordance with an embodiment. In operation 3701, the AP receives request frames from STAs indicating their representative behavior and preference of being a representative.

In operation 3703, the AP confirms the reception of the frames and processes them.

In operation 3705, the AP, after analyzing each frame, announces the roles to the STAs.

In operation 3707, the AP receives the acknowledgement from each STA confirming the reception.

In some embodiments, when the AP is requiring or may require reducing overhead due to a large number of clients, it may appoint a representative STA directly by analyzing the response frames from the STAs.

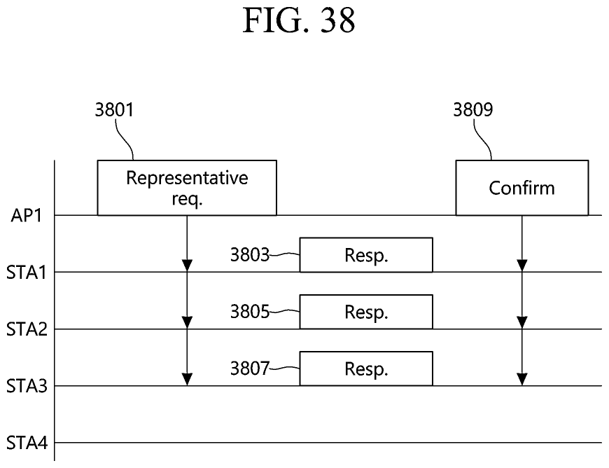

As illustrated in FIG. 38, first, the AP, AP1, transmits a representative request frame 3801 to its associated STAs, STA1, STA2, and STA3, the information items can be similar to Table 5 and Table 7. If the STA may not be able to support the representative capability such as STA4 as a legacy device, it may ignore the request. STA1, STA2, and STA3 who have the representative capability may each respond, STA1 response 3803, STA2 response 3805, and STA3 response 3807, with a status code as SUCCESS together with its preference or representative rank, if it would like to join a representative group and help to reduce the overhead of the AP. Otherwise, STAs may also decline the request by setting the status code to Request_Declined in the response frame. The information items listed in the response frame may include the information set out in Table 8. The AP receiving the response frames from the STAs may then need to process the frames, decide if the representative group can be formed, select the STA with highest preference as the representative STA, and others are represented STAs. The AP may announce the results in the confirmation frame 3809 to the STAs to form the representative group.

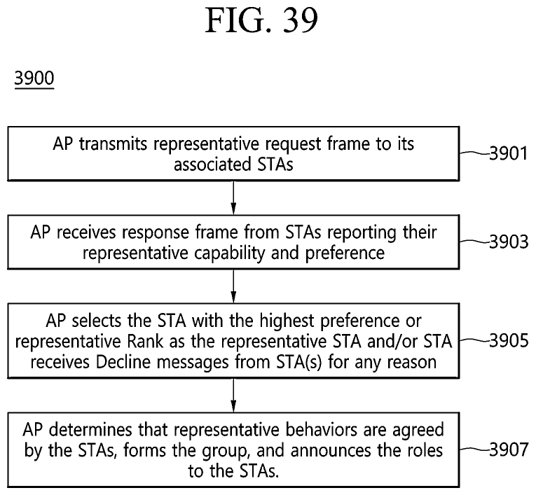

FIG. 39 illustrates a flowchart of an example process of representative negotiation procedure determined by an AP in accordance with an embodiment. In operation 3901, the AP transmits a representative request to its associated STAs.

In operation 3903, the AP receives response frames from the STAs reporting their representative capability and preference.

In operation 3905, the AP selects the STA with the highest preference or representative rank as the representative STA. The AP may also receive Decline messages from the STAs for any reason.

In operation 3907, the AP determines that the representative behaviors are agreed by the STAs and a group can be formed, the AP announces the roles to the STAs.

In operation 3907, if the AP determines that the representative behaviors are not agreed by the STAs, the representative behavior is failed.

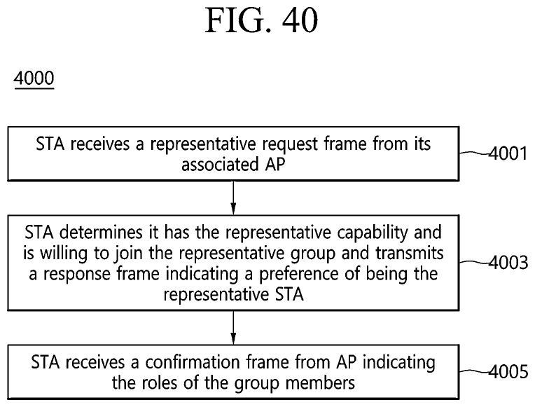

FIG. 40 illustrates a flowchart of an example process of representative negotiation procedure at a peer STA in accordance with an embodiment.

In operation 4001, the STA receives a representative request frame from its associated AP.

In operation 4003, the STA determines it has the representative capability and is willing to join the representative group and responds with a response frame indicating the preference of being the representative, or the STA declines the request.

In operation 4005 the STA receives a confirmation frame indicating the roles and group members.

In some embodiments, when an STA is approaching or leaving an existing P2P group, it may join or disconnect the group using existing protocols, for example, the invitation procedure or de-authentication procedure of WiFi direct, or NAN synchronization procedure of WiFi aware. In some embodiments, to indicate the representative capability, the representative STA may broadcast its group information in a beacon frame to the neighboring approaching STAs with the representative element which may include the information in Table 5. If STA4 prefers to join the group and agrees the representative capability, it could send a service requesting frame to representative STA with similarly information as set out in Table 7.

In some embodiments, the representative STA can also invite an STA to join the representative group by sending a modified invitation request frame with the representative capability. If the STA accepts to join, then it may indicate in the invitation response frame with the representative capability. Otherwise, the STA may decline the frame. After joining the group, the representative STA and the represented STA may provide an update to the AP. In some embodiments, these techniques may also be processed with the assistance of the AP. For example, when an STA is aware of the representative group from the beacon frames, it can indicate its representative preference to the AP to join the group. The AP may then compare the preferences with the current group, and update or maintain the roles.

In some embodiments, an STA can stay in a current P2P group but disable the representative capability. Due to the DL or UL traffic, an STA may have to indicate itself as in the awake state to AP, which may automatically disconnect the STA with the representative function. An STA can rejoin the representative group by indicating, to the representative STA, the representative preference or capability in the service request frame. In some embodiments, a represented STA can also indicate to leave (or disconnect or teardown) with the P2P group. The teardown could be sent to its representative STA and, if the peer STA is not reachable via the direct link, the teardown frame can be sent through the AP.

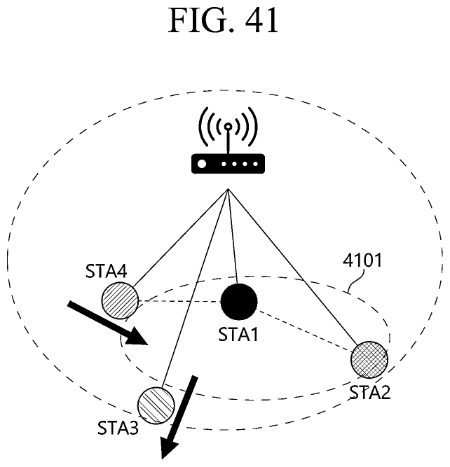

FIG. 41 illustrates an example of an STA joining and leaving a group in accordance with an embodiment. As illustrated, STA1 and STA2 are in a P2P group 4101, and STA4 is joining the P2P group while STA3 is leaving the P2P group.

In some embodiments, when the representative STA plans to leave a group, it may broadcast a teardown frame and dismiss the roles. The representative STA may also handover the roles to another STA in the group.

In some embodiments, the STA can assign the role based on the representative preference indicated in the previous frames.

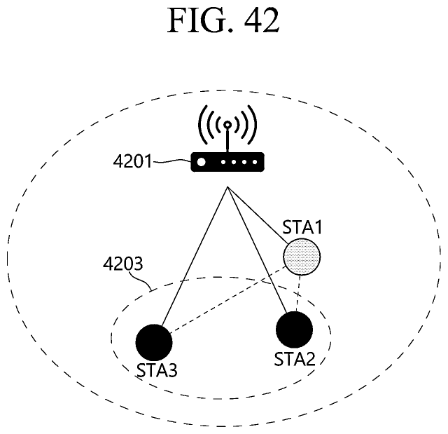

As illustrated in FIG. 42, AP 4201 is associated with STA1, STA2, and STA3. STA1, who is currently the representative STA, is leaving the P2P group 4203 that includes STA2 and STA3, and before it leaves, it transmits a handover request frame to the candidate who may have the second highest rank of the representative preference, and the candidate may respond with a handover response frame if the candidate STA is willing to become a representative STA. Then STA3 may perform the similar steps described herein.

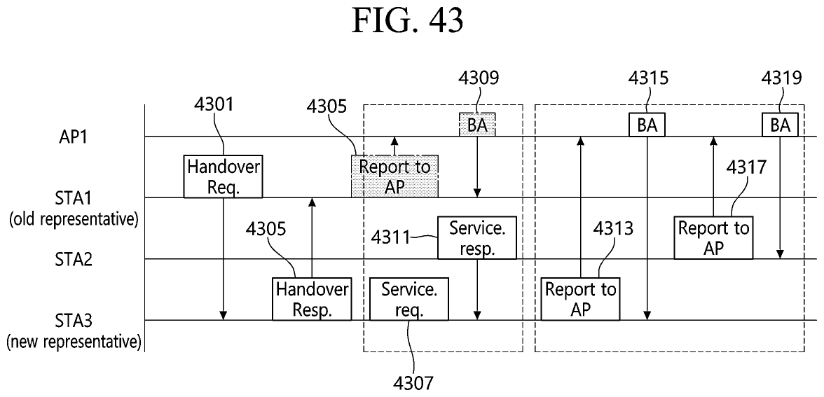

FIG. 43 illustrates an example of a representative STA planning to leave a group and handover the roles to other candidates in accordance with an embodiment. As illustrated, STA1, the old representative, transmits a handover request frame 4301 to STA3, the new representative to handover the representative role to STA3. The handover request frame may include the user information list indicating the current roles. STA3 transmits a handover response frame 4303 to STA1 to accept or decline the request. However, if STA3 declines the request with a code such as Handover_Fail, STA1 may then send a teardown frame to dismiss the group, or it may try another STA. During the service negotiation procedure between the new candidate STA3 and STA2, the preference value could be updated between the two.

If STA1 accepts the request, then STA1 transmits a report frame 4305 to AP1 to notify AP1 that STA1 is leaving the group and AP1 transmits an acknowledgement 4309 to STA1. STA3 transmits a service request frame 4307 to STA2 to notify STA2 that STA3 is the representative STA and STA2 transmits a service response frame 4311 indicating that STA2 is a represented STA to STA3.

STA3 transmits a report frame 4313 to the AP1 to notify the AP that STA3 is the representative STA. AP1 transmits an acknowledgement frame 4315 to STA3. STA2 transmits a report frame 4317 to AP1 to notify the AP that STA2 is a represented STA and AP1 transmits an acknowledgement frame 4319 to STA2.

Finally, the new representative STA may report its new role and represented STA's information to the AP. In some embodiments, the representative group may update their representative value frequently during the data transmission.

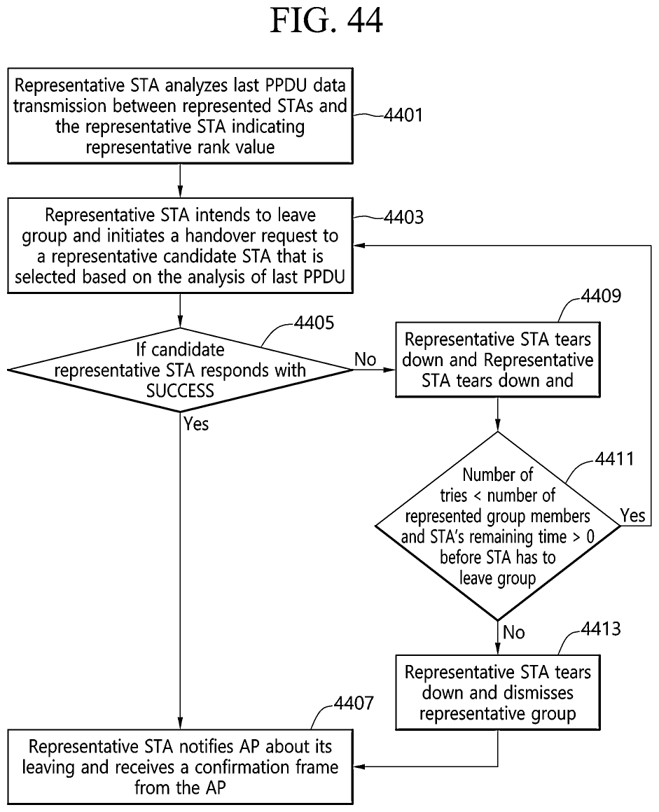

FIG. 44 illustrates a flow chart of an example process of a handover in accordance with an embodiment.

In operation 4401, the representative STA may determine the last data transmission between the represented STAs and the representative STA indicating the representative rank value.

In operation 4403, the representative STA may determine that it wants to leave the group and initiates a handover request to the representative candidate who is selected based on the elements in the last PPDUs.

In operation 4405, the representative STA determines if the candidate representative responds with SUCCESS.

If the representative STA determines that the candidate representative responds with SUCCESS, in operation 4407, the representative STA notifies the AP about leaving the group and receives a confirmation frame from the AP.

If the representative STA determines that the candidate representative does not respond with SUCCESS, in operation 4409, the representative STA tries another STA.

In operation 4411, the representative STA determines whether the number of tries is less than the number of represented group members and the remaining time is greater than zero before the representative STA has to leave.

If the representative STA determines that the number of tries is less than the number of represented group members and the remaining time is greater than zero before the representative STA has to leave, the process returns to operation 4403.

If the representative STA determines that the number of tries is not less than the number of represented group members or that the remaining time is not greater than zero before the representative STA has to leave, in operation 4413 the old representative STA tears down and dismisses the representative group and proceeds to operation 4407.

In some embodiments, the representative STA may perform handover through the help of the AP. The old representative STA may broadcast a beacon about its leaving to the represented STAs. Other STAs can also broadcast beacons about their intention of reselection with the help of the AP according to the procedures discussed herein. The rest of the STAs may indicate to the AP and then the AP may re-assign the roles.

In some embodiments, for periodic P2P transmission, except for the P2P indication frame, a Target “Sleep” Time (TST) or Target Unavailability Time indicating for the unavailability of P2P group activities could be setup for the P2P transmission.

In some embodiments, if a WiFi direct group is going to join the nearby AP, the group owner (GO) in the WiFi direct group can become the representative STA, and transmit the frame with AP on behalf of the other STAs. In certain embodiments, if the representative negotiation has been done and the roles have been determined, either by themselves or with the help of AP, the representative STA can also become the GO to form a further WiFi direct group.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, the first STA comprising:
a memory;
a processor coupled to the memory, the processor configured to:
communicate with a second STA on a first channel;
determine a need to switch to a second channel;
determine that the first STA is a representative STA and the second STA is a represented STA;
transmit a frame to an access point (AP) to notify the AP of a power save (PS) mode for the first STA and the second STA;
perform a channel switch to the second channel; and
communicate with the second STA on the second channel as a peer to peer (P2P) group.

2. The first STA of claim 1, wherein the first STA initiates the switch to the second channel with the second STA, wherein the processor is configured to transmit a channel switch request frame to the second STA.

3. The first STA of claim 1, wherein the processor is configured to:
receive a channel switch request frame from the second STA;
processes the channel switch request frame and agree to switch channels to the second channel and become the representative STA on behalf of itself and the second STA;
contend for a medium; and
transmit a channel switch response frame to the second STA.

4. The first STA of claim 1, wherein the first STA is associated with the AP and the second STA is not associated with the AP in a basic service set (BSS) and the second STA uses a different P2P protocol.

5. The first STA of claim 1, wherein the first STA and the second STA are associated with the AP in a basis service set (BSS).

6. The first STA of claim 1, wherein the processor is configured to:
broadcast a first frame that includes a first preference rank of the first STA;
receive a second frame from the second STA that includes a second preference rank of the second STA; and
determine the representative STA and the represented STA based on the first preference rank and the second preference rank.

7. The first STA of claim 6, wherein the processor is configured to:
transmit a service request frame to the second STA to notify that the first STA intends to become the representative STA; and
receive a service negotiation response frame from the second STA to notify that the second STA intends to become the represented STA.

8. The first STA of claim 6, wherein the processor is configured to:
transmit a first frame to the AP that includes the first preference rank; and
received a second frame from the AP that sets the first STA as the representative STA and the second STA as the represented STA.

9. The first STA of claim 1, wherein the processor is configured to:
transmit a handover request frame to at least one of the second STA to set the second STA as the representative STA; and
transmit a report frame to the AP to notify the AP that the first STA is leaving the P2P group.

10. An access point (AP) device in a wireless network, the AP device comprising:
a memory;
a processor coupled to the memory, the processor configured to:
receive a plurality of frames from a plurality of stations (STAs) associated with the AP, including a first frame from a first STA and a second frame from a second STA;
determine that the first STA is a representative STA and the second STA is a represented STA based on the plurality of frames; and
transmit a frame to the first STA and a frame the second STA that specifies the role of the first STA as the representative STA and the second STA as the represented STA.

11. The AP device of claim 10, wherein the processor is configured to:
receive a frame from the first STA that indicates to put the first STA and the second STA into a power save (PS) mode; and
set the first STA and the second STA into the PS mode.

12. The AP device of claim 10, wherein the processor is configured to:
transmit a representative request frame to the plurality of STAs associated with the AP to trigger the plurality of frames from the plurality of STAs.

13. The AP device of clam 10, wherein the processor is configured to:
determine ranks for the plurality of STAs; and
set roles for the STAs, including the representative STA and the represented STA, based on the ranks.

14. The AP device of claim 10, wherein the processor is configured to:
receive a handover request frame from the first STA;
set the second STA as the representative STA; and
transmit a frame to the second STA that updates the role of the second STA to the representative STA.

15. A computer-implemented method for facilitating communication at a first station (STA) in a wireless network, the method comprising:
communicating with a second STA on a first channel;
determining a need to switch to a second channel;
determining that the first STA is a representative STA and the second STA is a represented STA;
transmitting a frame to an access point (AP) to notify the AP of a power save (PS) mode for the first STA and the second STA;
performing a channel switch to the second channel; and
communicating with the second STA on the second channel as a peer to peer (P2P) group.

16. The computer-implemented method of claim 15, wherein the first STA initiates the switch to the second channel with the second STA, wherein the method further comprises transmitting a channel switch request frame to the second STA.

17. The computer-implemented method of claim 15, further comprising:
receiving a channel switch request frame from the second STA;
processing the channel switch request frame and agree to switch channels to the second channel and become the representative STA on behalf of itself and the second STA;
contending for a medium; and
transmitting a channel switch response frame to the second STA.

18. The computer-implemented method of claim 15, wherein the first STA is associated with the AP and the second STA is not associated with the AP in a basic service set (BSS) and the second STA uses a different P2P protocol.

19. The computer-implemented method of claim 15, wherein the first STA and the second STA are associated with the AP in a basis service set (BSS).

20. The computer-implemented method of claim 15, further comprising:
broadcasting a first frame that includes a first preference rank of the first STA;
receiving a second frame from the second STA that includes a second preference rank of the second STA; and
determining the representative STA and the represented STA based on the first preference rank and the second preference rank.
